(19) United States
(12) Patent Application Publication
(10) Pub. No.: US 2012/0003923 A1
(43) Pub. Date: Jan. 5, 2012

(54) FLOATING AND FIXED TIME MERCHANDISING AND ACCESS CONTROL

(75) Inventors: Carlos Pazos, San Diego, CA (US); Ajit Jain, San Diego, CA (US); Panagiotis Thomas, San Diego, CA (US)

(73) Assignee: QUALCOMM Incorporated, San Diego, CA (US)

(21) Appl. No.: 12/828,693

(22) Filed: Jul. 1, 2010

(51) Int. Cl. H04W 4/06

(52) U.S. Cl. 455/3.06

(57) ABSTRACT

A mobile broadcast system configured to provide time-based merchandising and access control includes: a distribution module configured to transmit system information to a user device, wherein the system information includes time-based subscription information for one or more service packages, to receive a subscription request indicating a selected service package, to determine if the user device is authorized to receive the selected service package; and to transmit a subscription response to the user device.

### BACKGROUND

A mobile broadcast system can be or include a wireless content delivery system, such as the MediaFLO™ system developed by QUALCOMM Incorporated of San Diego, Calif. The mobile broadcast system can be or include a content delivery platform based on wired or optical connections, in addition to or instead of a wireless interface. In general, the content delivered by the mobile broadcast system can include video media, such as video clips encoded in the Real™ format, the Motion Pictures Group (.mpg) format, the Windows Media format by Microsoft Corp., or other video codec or format. Content can also include audio media, such as music tracks or broadcast recordings encoded in Motion Pictures Expert Group (MPEG)-1 Audio Layer 3 (MP3) format, Microsoft Corp. “.wav” format, RealAudio™ format, or other audio codec or format. Content can further include textual content, such as streaming stock quotes, weather reports, or other data.

The mobile broadcast system can additionally be configured to group content or services into one or more service packages. Users operating user devices can then select to purchase subscription packages associated with the one or more service packages. Purchasing a subscription package allows a user to access and utilize services associated with the package.

Subscription packages can be offered for purchase on a monthly recurring basis. Some mobile broadcast systems may also be configured to offer shorter term or event based subscription package options that might better suit user needs. This offers more flexible subscription options to users.

### SUMMARY

An example of a mobile broadcast system configured to provide time-based merchandising and access control according to the disclosure includes: a distribution module configured to transmit system information to a user device, wherein the system information includes time-based subscription information for one or more service packages; the distribution module configured to receive a subscription request indicating a selected service package; the distribution module configured to determine if the user device is authorized to receive the selected service package; and the distribution module configured to transmit a subscription response to the user device.

Embodiments of such a system may include one or more of the following features. The time-based subscription information includes fixed time subscription information for one or more of the one or more service packages. The fixed time subscription information for the one or more of the one or more service packages includes a start time and end time for each service package. The time-based subscription information includes floating time subscription information for one or more of the one or more service packages. The floating time subscription information for the one or more of the one or more service packages includes a duration for each service package. The duration for each service package is the product of a multiplier and a base duration. The subscription request is a request to subscribe to the selected service package via a first time-based subscription. The first time-based subscription is a fixed time subscription. The first time-based subscription is a floating time subscription. The distribution module is further configured to determine a subscription lifetime period based on the first time-based subscription. Determining of the subscription lifetime period is also based on a second time-based subscription for the selected service package. The distribution module is further configured to generate one or more service keys. A service key is generated for one or more epochs. The subscription lifetime period overlaps with at least a portion of each of the one or more epochs. Each generated service key includes service key lifetime information. The service key lifetime information includes a start time and end time. Each generated service key includes a service key lifetime signature. The distribution module is further configured to transmit a service license message to the user device, wherein the service license message includes one or more service keys. The subscription request is a request to unsubscribe from the selected service package.

An example of a system for handling time-based merchandising and providing access control includes: a user device configured to receive system information including time-based subscription information for one or more service packages, to provide an indication of service packages available via time-based subscriptions based on the time-based subscription information for the one or more service packages, to receive a selection of a service package available via a time-based subscription; and to transmit a subscription request.

Embodiments of such a system may include one or more of the following features. The time-based subscription information includes a closed element for one or more time-based subscriptions for the one or more service packages, the closed element for each respective time-based subscription indicating whether an associated service package is available for time-based subscription. The time-based subscription information includes an unsubscription element for one or more time-based subscriptions for the one or more service packages, the unsubscription element for each respective subscription indicating whether the user device can unsubscribe from an associated time-based service package. The subscription request is a request to unsubscribe from the selected service package. The subscription request is a request to subscribe to the selected service package via a time-based subscription. The user device is further configured to receive a subscription response, and transmit a service license request. The user device is further configured to receive a service license message including one or more service keys for the selected service package. Each service key for the selected service package includes service key lifetime information and a service key lifetime signature. The user device is further configured to verify service key lifetime information using the service key lifetime signature. The user device is further configured to: receive an access request to a service associated with the selected service package; select a service key associated with the service; and determine if the selected service key is valid. Determining if the service key is valid includes verifying the service key lifetime information associated with the selected service key using the service key lifetime signature associated with the selected service key; and determining if a current time is within a time period defined by the service key lifetime information associated with the selected service key. The user device is further configured to provide access to the service associated with the selected service package if the selected service key associated with the service is determined to be valid.

An example of a method for providing time-based merchandising and access control in a mobile broadcast system includes: transmitting system information to a user device, wherein the system information includes time-based subscription information for one or more service packages, receiving a subscription request indicating a selected service package, determining if the user device is authorized to receive the selected service package; and transmitting a subscription response to the user device.

Embodiments of such a method may include one or more of the following features. The time-based subscription information includes fixed time subscription information for one or more of the one or more service packages. The fixed time subscription information for the one or more of the one or more service packages includes a start time and end time for each service package. The time-based subscription information includes floating time subscription information for one or more of the one or more service packages. The floating time subscription information for the one or more of the one or more service packages includes a duration for each service package. The duration for each service package is the product of a multiplier and a base duration. The subscription request is a request to subscribe to the selected service package via a first time-based subscription. The first time-based subscription is a fixed time subscription. The first time-based subscription is a floating time subscription.

The method further includes determining a subscription lifetime period based on the first time-based subscription. Determining a subscription lifetime period is also based on a second time-based subscription for the selected service package. The method further includes generating one or more service keys. A service key is generated for one or more epochs. The subscription lifetime period overlaps with at least a portion of each of the one or more epochs. Each generated service key includes service key lifetime information. The service key lifetime information includes a start time and end time. Each generated service key includes a service key lifetime signature. The method further includes transmitting a service license message to the user device, wherein the service license message includes one or more service keys. The subscription request is a request to unsubscribe from the selected service package.

An example of a method for handling time-based merchandising and providing access control includes: receiving system information including time-based subscription information for one or more service packages; providing an indication of service packages available via time-based subscriptions based on the time-based subscription information for the one or more service packages; receiving a selection of a service package available via a time-based subscription; and transmitting a subscription request.

Embodiments of such a method may include one or more of the following features. The time-based subscription information includes a closed element for one or more time-based subscriptions for the one or more service packages, the closed element for each respective time-based subscription indicating whether an associated service package is available for time-based subscription. The time-based subscription information includes an unsubscription element for one or more time-based subscriptions for the one or more service packages, the unsubscription element for each respective subscription indicating whether the user device can unsubscribe from an associated time-based service package. The subscription request is a request to unsubscribe from the selected service package. The subscription request is a request to subscribe to the selected service package via a time-based subscription. The method further includes receiving a subscription response, and transmitting a service license request. The method further includes receiving a service license message including one or more service keys for the selected service package. Each service key for the selected service package includes service key lifetime information and a service key lifetime signature. The method further includes verifying service key lifetime information using the service key lifetime signature. The method further includes: receiving an access request to a service associated with the selected service package; selecting a service key associated with the service; and determining if the selected service key is valid. Determining if the service key is valid includes: verifying the service key lifetime information associated with the selected service key using the service key lifetime signature associated with the selected service key; and determining if a current time is within a time period defined by the service key lifetime information associated with the selected service key. The method further includes providing access to the service associated with the selected service package if the selected service key associated with the service is determined to be valid.

An example of a computer program product includes a processor-readable medium storing processor-readable instructions configured to cause a processor to: transmit system information to a user device, wherein the system information includes time-based subscription information for one or more service packages, receive a subscription request indicating a selected service package, determine if the user device is authorized to receive the selected service package, and transmit a subscription response to the user device.

Embodiments of such a product may include one or more of the following features. The time-based subscription information includes fixed time subscription information for one or more of the one or more service packages. The fixed time subscription information for the one or more of the one or more service packages includes a start time and end time for each service package. The time-based subscription information includes floating time subscription information for one or more of the one or more service packages. The floating time subscription information for the one or more of the one or more service packages includes a duration for each service package. The duration for each service package is the product of a multiplier and a base duration. The subscription request is a request to subscribe to the selected service package via a first time-based subscription. The first time-based subscription is a fixed time subscription. The first time-based subscription is a floating time subscription. The instructions are further configured to cause the processor to determine a subscription lifetime period based on the first time-based subscription. Determining the subscription lifetime period is also based on a second time-based subscription for the selected service package. The instructions are further configured to cause the processor to generate one or more service keys. A service key is generated for one or more epochs. The subscription lifetime period overlaps with at least a portion of each of the one or more epochs. Each generated service key includes service key lifetime information. The service key lifetime information includes a start time and end time. Each generated service key includes a service key lifetime signature. The instructions are further configured to cause the processor to transmit a service license message to the user device, wherein the service license message includes one or more service keys. The subscription request is a request to unsubscribe from the selected service package.

An example of a computer program product includes a processor-readable medium storing processor-readable instructions configured to cause a processor to: receive system information including time-based subscription information for one or more service packages; provide an indication of service packages available via time-based subscriptions based on the time-based subscription information for the one or more service packages; receive a selection of a service package available via a time-based subscription; and transmit a subscription request.

Embodiments of such a product may include one or more of the following features. The time-based subscription information includes a closed element for one or more time-based subscriptions for the one or more service packages, the closed element for each respective time-based subscription indicating whether an associated service package is available for time-based subscription. The time-based subscription information includes an unsubscription element for one or more time-based subscriptions for the one or more service packages, the unsubscription element for each respective subscription indicating whether the user device can unsubscribe from an associated time-based service package. The subscription request is a request to unsubscribe from the selected service package. The subscription request is a request to subscribe to the selected service package via a time-based subscription. The instructions are further configured to cause the processor to receive a subscription response, and transmit a service license request. The instructions are further configured to cause the processor to receive a service license message including one or more service keys for the selected service package. Each service key for the selected service package includes service key lifetime information and a service key lifetime signature. The instructions are further configured to cause the processor to verify service key lifetime information using the service key lifetime signature. The instructions are further configured to cause the processor to: receive an access request to a service associated with the selected service package, select a service key associated with the service; and determine if the selected service key is valid. Determining if the service key is valid includes: verifying the service key lifetime information associated with the selected service key using the service key lifetime signature associated with the selected service key; and determining if a current time is within a time period defined by the service key lifetime information associated with the selected service key. The instructions are further configured to cause the processor to provide access to the service associated with the selected service package if the selected service key associated with the service is determined to be valid.

An example of a mobile broadcast system configured to provide time-based merchandising and access control includes: means for transmitting system information to a user device, wherein the system information includes time-based subscription information for one or more service packages, means for receiving a subscription request indicating a selected service package, means for determining if the user device is authorized to receive the selected service package, and means for transmitting a subscription response to the user device.

Embodiments of such a system may include one or more of the following features. The time-based subscription information includes fixed time subscription information for one or more of the one or more service packages. The fixed time subscription information for the one or more of the one or more service packages includes a start time and end time for each service package. The time-based subscription information includes floating time subscription information for one or more of the one or more service packages. The floating time subscription information for the one or more of the one or more service packages includes a duration for each service package. The duration for each service package is the product of a multiplier and a base duration. The subscription request is a request to subscribe to the selected service package via a first time-based subscription. The first time-based subscription is a fixed time subscription. The first time-based subscription is a floating time subscription. The system further includes means for determining a subscription lifetime period based on the first time-based subscription. Determining the subscription lifetime period is also based on a second time-based subscription for the selected service package. The system further includes means for generating one or more service keys. A service key is generated for one or more epochs. The subscription lifetime period overlaps with at least a portion of each of the one or more epochs. Each generated service key includes service key lifetime information. The service key lifetime information includes a start time and end time. Each generated service key includes a service key lifetime signature. The system includes means for transmitting a service license message to the user device, wherein the service license message includes one or more service keys. The subscription request is a request to unsubscribe from the selected service package.

An example of a system configured for handling time-based merchandising and providing access control includes: means for receiving system information including time-based subscription information for one or more service packages; means for providing an indication of service packages available via time-based subscriptions based on the time-based subscription information for the one or more service packages; means for receiving a selection of a service package available via a time-based subscription; and means for transmitting a subscription request.

Embodiments of such a system may include one or more of the following features. The time-based subscription information includes a closed element for one or more time-based subscriptions for the one or more service packages, the closed element for each respective time-based subscription indicating whether an associated service package is available for time-based subscription. The time-based subscription information includes an unsubscription element for one or more time-based subscriptions for the one or more service packages, the unsubscription element for each respective subscription indicating whether the user device can unsubscribe from an associated time-based service package. The subscription request is a request to unsubscribe from the selected service package. The subscription request is a request to subscribe to the selected service package via a time-based subscription. The system further includes means for receiving a subscription response, and transmitting a service license request. The system further includes means for receiving a service license message including one or more service keys for the selected service package. Each service key for the selected service package includes service key lifetime information and a service key lifetime signature. The system further includes means for verifying service key lifetime information using the service key lifetime signature. The system further includes: means for receiving an access request to a service associated with the selected service package; means for selecting a service key associated with the service; and means for determining if the selected service key is valid. Determining if the service key is valid includes: verifying the service key lifetime information associated with the selected service key using the service key lifetime signature associated with the selected service key; and determining if a current time is within a time period defined by the service key lifetime information associated with the selected service key. The system further includes means for providing access to the service associated with the selected service package if the selected service key associated with the service is determined to be valid.

An example of a mobile broadcast system configured to provide time-based merchandising and access control includes: a provisioning module configured to create a package record for a first instance of a service package, to close the first instance of the service package at a first time after a first duration, to create a package record for a second instance of the service package at the first time, and a distribution module configured to transmit system information to one or more user devices, wherein the system information includes information about the first instance of the service package indicating that the first instance of the service package is available for subscription and to transmit updated system information to the one or more user devices, wherein the updated system information includes information indicating that the first instance of the service package is closed and information about the second instance of the service package indicating that the second instance of the service package is available for subscription.

Embodiments of such a system may include one or more of the following features. Closing the first instance of the service package indicates that the first instance of the service package is no longer available for subscription. The provisioning module is further configured to delete the package record for the first instance of the service package at a second time after a second duration, and the distribution module is further configured to transmit updated system information to the one or more user devices, wherein the updated system information includes information indicating that the first instance of the service package is deleted. The information indicates that the first instance of the service package is deleted by omitting information about the first instance of the service package in the updated system information. The provisioning module is further configured to close the second instance of the service package at a third time after a third duration and to create a package record for a third instance of the service package at the third time, and the distribution module is further configured to transmit updated system information to the one or more user devices, wherein the updated system information includes information indicating that the second instance of the service package is closed and information about the third instance of the service package indicating that the third instance of the service package is available for subscription. Closing the second instance of the service package indicates that the second instance of the service package is no longer available for subscription. The first duration is equal in time to the third duration. The provisioning module is further configured delete the package record for the second instance of the service package at a fourth time after a fourth duration, and the distribution module is further configured to transmit updated system information to the one or more user devices, wherein the updated system information includes information indicating that the second instance of the service package is deleted. The information indicates that the second instance of the service package is deleted by omitting information about the second instance of the service package in the updated system information. The second duration is equal in time to the fourth duration.

An example of a system for handling time-based merchandising and providing access control, the system includes: a user device configured to receive system information including subscription information for one or more service packages, transmit a subscription request including a service package selection, receive a service license message including one or more service keys for the selected service package, receive updated system information including subscription information for one or more service packages, determine if the updated system information includes subscription information for the selected service package, and delete the one or more service keys for the selected service package if subscription information for the selected service package is not present in the updated system information. Embodiments of such a system may include the following feature. Deleting the service keys terminates access to services associated with the service keys.

An example of a method of providing time-based merchandising and access control in a mobile broadcast system includes: creating a package record for a first instance of a service package, transmitting system information to one or more user devices, wherein the system information includes information about the first instance of the service package indicating that the first instance of the service package is available for subscription, closing the first instance of the service package at a first time after a first duration, creating a package record for a second instance of the service package at the first time, and transmitting updated system information to the one or more user devices, wherein the updated system information includes information indicating that the first instance of the service package is closed and information about the second instance of the service package indicating that the second instance of the service package is available for subscription.

Embodiments of such a method may include one or more of the following features. Closing the first instance of the service package indicates that the first instance of the service package is no longer available for subscription. The method further includes deleting the package record for the first instance of the service package at a second time after a second duration, and transmitting updated system information to the one or more user devices, wherein the updated system information includes information indicating that the first instance of the service package is deleted. The information indicates that the first instance of the service package is deleted by omitting information about the first instance of the service package in the updated system information. The method further includes: closing the second instance of the service package at a third time after a third duration, creating a package record for a third instance of the service package at the third time, and transmitting updated system information to the one or more user devices, wherein the updated system information includes information indicating that the second instance of the service package is closed and information about the third instance of the service package indicating that the third instance of the service package is available for subscription. Closing the second instance of the service package indicates that the second instance of the service package is no longer available for subscription. The first duration is equal in time to the third duration. The method further includes: deleting the package record for the second instance of the service package at a fourth time after a fourth duration, and transmitting updated system information to the one or more user devices, wherein the updated system information includes information indicating that the second instance of the service package is deleted. The information indicates that the second instance of the service package is deleted by omitting information about the second instance of the service package in the updated system information. The second duration is equal in time to the fourth duration.

An example of a method for handling time-based merchandising and providing access control includes: receiving system information including subscription information for one or more service packages; transmitting a subscription request including a service package selection; receiving a service license message including one or more service keys for the selected service package; receiving updated system information including subscription information for one or more service packages; determining if the updated system information includes subscription information for the selected service package; and deleting the one or more service keys for the selected service package if subscription information for the selected service package is not present in the updated system information. Embodiments of such a method may include the following feature. Deleting the service keys terminates access to services associated with the service keys.

An example of a computer program product includes a processor-readable medium storing processor-readable instructions configured to cause a processor to: create a package record for a first instance of a service package, transmit system information to one or more user devices, wherein the system information includes information about the first instance of the service package indicating that the first instance of the service package is available for subscription, close the first instance of the service package at a first time after a first duration, create a package record for a second instance of the service package at the first time, and transmit updated system information to the one or more user devices, wherein the updated system information includes information indicating that the first instance of the service package is closed and information about the second instance of the service package indicating that the second instance of the service package is available for subscription.

Embodiments of such a product may include one or more of the following features. Closing the first instance of the service package indicates that the first instance of the service package is no longer available for subscription. The instructions are further configured to cause the processor to: delete the package record for the first instance of the service package at a second time after a second duration, and transmit updated system information to the one or more user devices, wherein the updated system information includes information indicating that the first instance of the service package is deleted. The information indicates that the first instance of the service package is deleted by omitting information about the first instance of the service package in the updated system information. The instructions are further configured to cause the processor to: close the second instance of the service package at a third time after a third duration, create a package record for a third instance of the service package at the third time, and transmit updated system information to the one or more user devices, wherein the updated system information includes information indicating that the second instance of the service package is closed and information about the third instance of the service package indicating that the third instance of the service package is available for subscription. Closing the second instance of the service package indicates that the second instance of the service package is no longer available for subscription. The first duration is equal in time to the third duration. The instructions are further configured to cause the processor to: delete the package record for the second instance of the service package at a fourth time after a fourth duration, and transmit updated system information to the one or more user devices, wherein the updated system information includes information indicating that the second instance of the service package is deleted. The information indicates that the second instance of the service package is deleted by omitting information about the second instance of the service package in the updated system information. The second duration is equal in time to the fourth duration.

An example of a computer program product includes: a processor-readable medium storing processor-readable instructions configured to cause a processor to: receive system information including subscription information for one or more service packages; transmit a subscription request including a service package selection; receive a service license message including one or more service keys for the selected service package; receive updated system information including subscription information for one or more service packages; determine if the updated system information includes subscription information for the selected service package; and delete the one or more service keys for the selected service package if subscription information for the selected service package is not present in the updated system information. Embodiments of such a product may include the following feature. Deleting the service keys terminates access to services associated with the service keys.

An example of a mobile broadcast system configured to provide time-based merchandising and access control includes: a means for creating a package record for a first instance of a service package, a means for transmitting system information to one or more user devices, wherein the system information includes information about the first instance of the service package indicating that the first instance of the service package is available for subscription, a means for closing the first instance of the service package at a first time after a first duration, a means for creating a package record for a second instance of the service package at the first time, and a means for transmitting updated system information to the one or more user devices, wherein the updated system information includes information indicating that the first instance of the service package is closed and information about the second instance of the service package indicating that the second instance of the service package is available for subscription.

Embodiments of such a system may include one or more of the following features. Closing the first instance of the service package indicates that the first instance of the service package is no longer available for subscription. The system further includes: means for deleting the package record for the first instance of the service package at a second time after a second duration, and means for transmitting updated system information to the one or more user devices, wherein the updated system information includes information indicating that the first instance of the service package is deleted. The information indicates that the first instance of the service package is deleted by omitting information about the first instance of the service package in the updated system information. The system further includes: means for closing the second instance of the service package at a third time after a third duration, means for creating a package record for a third instance of the service package at the third time, and means for transmitting updated system information to the one or more user devices, wherein the updated system information includes information indicating that the second instance of the service package is closed and information about the third instance of the service package indicating that the third instance of the service package is available for subscription. Closing the second instance of the service package indicates that the second instance of the service package is no longer available for subscription. The first duration is equal in time to the third duration. The system further includes: means for deleting the package record for the second instance of the service package at a fourth time after a fourth duration, and means for transmitting updated system information to the one or more user devices, wherein the updated system information includes information indicating that the second instance of the service package is deleted. The information indicates that the second instance of the service package is deleted by omitting information about the second instance of the service package in the updated system information. The second duration is equal in time to the fourth duration.

An example of a system configured for handling time-based merchandising and providing access control includes: means for receiving system information including subscription information for one or more service packages; means for transmitting a subscription request including a service package selection; means for receiving a service license message including one or more service keys for the selected service package; means for receiving updated system information including subscription information for one or more service packages; means for determining if the updated system information includes subscription information for the selected service package; and means for deleting the one or more service keys for the selected service package if subscription information for the selected service package is not present in the updated system information. Embodiments of such a system may include the following feature. Deleting the service keys terminates access to services associated with the service keys.

Items and/or techniques described herein may provide one or more of the following capabilities. Floating and fixed time merchandising enable users to purchase subscription packages of varying durations. In particular, floating time subscriptions enable users to subscribe to service packages on hourly, daily, weekly, monthly, or yearly bases. Fixed time subscriptions enable users to subscribe to service packages with defined start and end times. Providing floating and fixed time merchandising enable users to purchase subscription packages that better suit their needs. While item/technique-effect pairs have been described, it may be possible for a noted effect to be achieved by means other than those noted, and a noted item/technique may not necessarily yield the noted effect.

### BRIEF DESCRIPTION OF THE DRAWINGS

FIG. 1 illustrates an exemplary mobile broadcast system.

FIG. 2 illustrates an exemplary MediaFLO™ system logical architecture.

FIG. 3 illustrates an exemplary architecture for a merchandising and access control system configured to provide fixed and floating time merchandising and access control.

FIG. 4 is a block flow diagram of a process for providing fixed and floating time merchandising and access control using the merchandising and access control system shown in FIG. 3, according to a first implementation.

FIG. 5 is a timing diagram showing the relationship between subscription lifetime periods, service key lifetimes and epochs.

FIG. 6 is a block flow diagram of a process for handling fixed and floating time merchandising on a user device in the merchandising and access control system shown in FIG. 3, according to a first implementation.

FIG. 7 illustrates an exemplary graphical user interface provided by a user device.

FIGS. 8A-8F illustrate exemplary protocol definitions.

FIG. 9 illustrates another exemplary architecture for a merchandising and access control system configured to provide fixed and floating time merchandising and access control.

FIG. 10 is a timing diagram demonstrating the manner in which multiple instances of a service package are created, closed, and deleted in order to provide floating time subscription packages.

FIG. 11 is a block flow diagram of a process for providing floating time merchandising and access control using the merchandising and access control system shown in FIG. 9, according to a second implementation.

FIG. 12 is a block flow diagram of a process for handling floating time merchandising on a user device in the merchandising and access control system shown in FIG. 9, according to a second implementation.

In the figures, components with similar relevant characteristics and/or features may have the same reference label.

### DETAILED DESCRIPTION

As used herein, a fixed time subscription package refers to a subscription that permits access to a service package of one or more services for a predetermined and fixed period of time. In a fixed time subscription package, the access period is the same for all users (i.e., the subscription package has the same start and end times for all users). However, users that subscribe after the start of an access period only receive access to the remaining access period. For example, a fixed time subscription may have a fixed access period between 10 a.m. and 12 p.m. No matter when a user purchases the subscription package within the access period, access is limited to the aforementioned time period. Fixed time subscription packages may be used for one-time events, such as NFL™ playoff games or FIFA World Cup™ matches. For example, a fixed time subscription package may define a 7 hour period of time that allows access to two back-to-back NFL™ playoff games.

As used herein, a floating time subscription package refers to a subscription that permits access to a service package of one or more services for a predetermined period of time. Unlike fixed time subscriptions, the access period for a floating time subscription package is not fixed to the same start and end times for all users. For example, a floating time subscription may offer an access period of one hour. A first user may purchase a subscription at 10 a.m., and would therefore have access to services provided by the subscription from 10 a.m. to 11 a.m. A second user may purchase a subscription package at 1 p.m., and would thus have access to services provided by the subscription package from 1 p.m. to 2 p.m.

As used herein, a time-based subscription package can refer to either a fixed time subscription package or a floating time subscription package.

Techniques described herein provide floating and fixed time merchandising and access control. Although the techniques for supporting time-based merchandising are described in the context of the MediaFLO™ broadcast system, the techniques are also generally applicable to other broadcast systems.

In one implementation, a distribution subsystem can transmit, to a user device, marketplace system information including information regarding available fixed and floating time subscriptions for one or more service packages. The information regarding the available fixed and floating time subscriptions can include timing information. A user device can be configured to use the marketplace system information to provide information about available subscription packages on a graphical user interface (GUI) to a user. The user may subsequently request to subscribe to one or more service packages via one or more time-based subscription packages. The user device can, in response, generate and transmit a subscription request to the distribution subsystem. The request may include timing information for the one or more requested time-based subscription packages. The distribution subsystem may process the request and provide encrypted service keys to the user device. The encrypted service keys may include service key lifetime information and lifetime signatures, which may be used to limit access to content.

In another implementation, a provisioning subsystem can automatically create, close, and delete multiple instances of floating service packages based on predetermined durations. More specifically, the provisioning subsystem can create an instance of a service package and allow users to subscribe to that instance of the service package. Upon subscribing to the instance, users can access the services associated with the service package. The provisioning subsystem can further close an instance of a service package after a first predetermined duration. After an instance of a service package is closed, users can no longer request to subscribe to that instance of the service package. The provisioning subsystem can also delete an instance of a service package after a second predetermined duration. After the instance of the service package is deleted, subscribed users can no longer access the services associated with the instance of the service package. Other implementations are within the scope of the disclosure and claims.

### Mobile Broadcast System

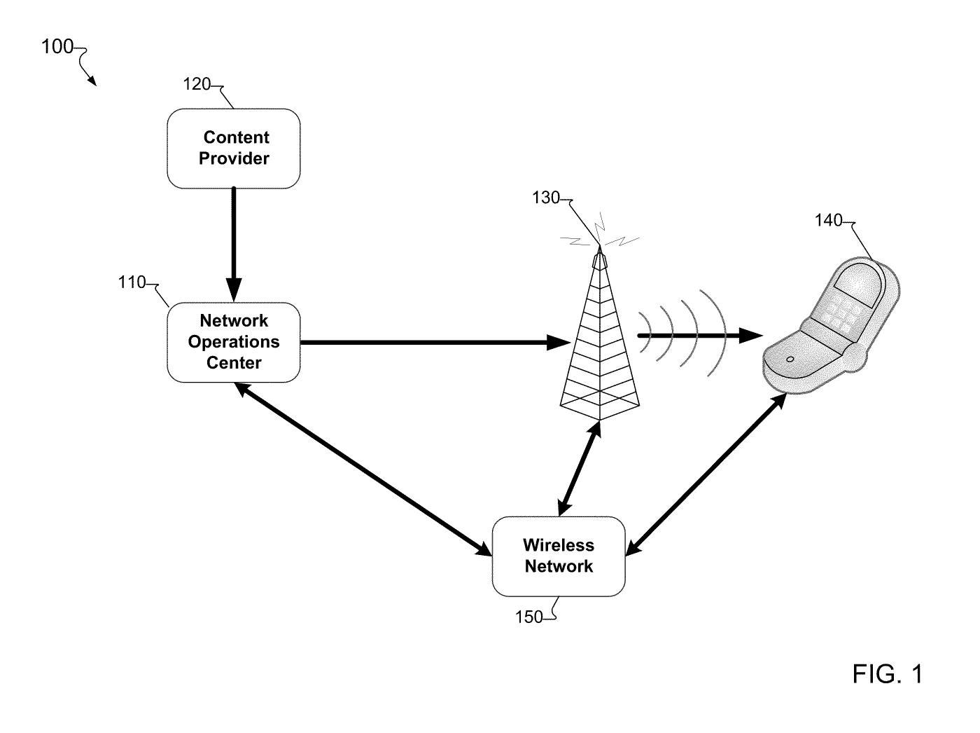

FIG. 1 illustrates an exemplary mobile broadcast system 100. The mobile broadcast system operates in accordance with the standards published by the FLO forum, and in particular is typified by the MediaFLO™ broadcast system by QUALCOMM Incorporated of San Diego, Calif. Using a cellular standard, such as GSM or CDMA, enables MediaFLO™ to provide security and services utilizing unicasting associated with a wireless paradigm. The MediaFLO™ mobile broadcast platform delivers content across a mobile environment. MediaFLO™ utilizes a combination of broadcast and wireless paradigms to provide business opportunities within a mobile broadcast ecosystem. Using the Forward Link Only (FLO) air interface standard, MediaFLO™ provides greater content capacity and reduced content delivery costs associated with broadcasting paradigms.

MediaFLO™, or FLO™, technology is designed to meet the mobile entertainment requirements of end users and service providers, by, for example, providing television services to end users and features designed to facilitate monetization by service providers. MediaFLO™ provides a broad range of content to mobile devices in a spectrally efficient, cost-effective and designed for low power consumption system. For example, the MediaFLO™ system can deliver streaming television, video and audio, Clipcast™ video and audio, and real-time Internet Protocol (IP) data services to MediaFLO™ compatible mobile devices. The mobile devices can selectively receive, display, play, store, and manipulate the content delivered over the mobile broadcast system 100. Devices usable with the MediaFLO™ system include smartphones, cellular phones, personal digital assistants (PDA), interactive game devices, notebooks, smartbooks, netbooks, data processing apparatus, or other such electronic devices.

MediaFLO™ also can be configured to group programming into one or more subscription packages. Users, or subscribers, operating MediaFLO™ compatible mobile devices can select one or more of the MediaFLO™ subscription packages. For example, reception and decoding of channels included in a MediaFLO™ subscription package can be enabled in response to user input, e.g., touching a touchscreen on a MediaFLO™ compatible mobile device. Any number of conditional access solutions (CAS) can be utilized for controlling access to MediaFLO™ content and services. Additionally, the mobile broadcast system 100 can maintain quality by providing service flexibility with variable bit rate encoding. Variable bit rate encoding balances bandwidth, which is important to the service operator, with high-quality audio and video, which makes the end user experience more enjoyable.

MediaFLO™ end user services can include real-time content delivery, such as video and audio presentations, audio only programming and audio with slides programming. In some implementations, the real-time services can include enhanced H.264 video and AAC+ audio formats. End user services also can include non-real-time content delivery, such as network scheduled delivery of audio clips, e.g., MP4, and multimedia files, e.g., JPEG, PNG, and HTML. Non-real-time services generally comprise the mobile device capturing specific pieces of multimedia and other data for presentation at a later time. For example, a non-real-time service called “clipcasting” provides network scheduled delivery of data services and files, such as wallpaper or e-coupons, for capture by a mobile device. Additionally, Clipcast can be implemented to deliver multimedia clips with multi-presentation views, e.g., from a plurality of perspectives, to a mobile device in accordance with a network schedule.

The mobile broadcast system 100 also can enable audio and video clips, or multimedia clips, to be stored at the MediaFLO™ compatible mobile device in internal memory, external memory, or both. End users can view, listen, and play any stored clip that has not expired. In some implementations, the mobile device can include a file cache size that is configurable by the service operator, the end user, or both.

Additionally, MediaFLO™ can offer end user IP data services, such as FLO network delivery of Internet traffic to third-party applications. Third-party mobile applications can provide end users with dynamic home pages, that include, e.g., stock, news, weather and sports information. For example, the delivery of IP data services can enable stock tickers to be tailored to a user's specific profile. Additionally, MediaFLO™ can be integrated with two-way data exchange applications, such as text and voice chat, live voting, email and web browsing, video-on-demand and shopping, in addition to other interactive mobile application features. With such interactivity, a user can obtain additional information associated with the real-time or non-real-time programming. For example, a dinner recipe may be downloaded during the broadcast of a cooking show and shared with a user's friends, e.g., via a SMS message.

Referring once again to FIG. 1, the mobile broadcast system 100 generally comprises multiple nodes 110-140 that communicate, for example, over a wireless network 150. The wireless network 150, also referred to as a “wireless communication system,” encompasses both the physical network as well as digital signal technology. The wireless network 150 can be implemented as: a code division multiple access (CDMA) system; a frequency division multiple access (FDMA) system; a time division multiple access (TDMA) system such as Global System for Mobile communications (GSM), GSM/General Packet Radio Service (GPRS), Enhanced Data GSM Environment (EDGE) or Terrestrial Trunked Radio (TETRA); a Wideband CDMA (WCDMA) system; Evolution Data Optimized (EV-DO) systems such as 1xEV-DO, EV-DO Rev A or EV-DO Rev B; High Speed Packet Access (HSPA) systems such as High Speed Downlink Packet Access (HSDPA), High Speed Uplink Packet Access (HSUPA) or Evolved High Speed Packet Access (HSPA+); a Long Term Evolution (LTE) system; or other communications systems, such as a system utilizing 3G or 4G technology. Content distributed over the interconnected nodes 110-140 can be selectively received, transmitted, processed, stored, and displayed.

The nodes of the mobile broadcast system 100 generally comprise a network operations center 110, one or more content providers 120, one or more FLO transmitters 130, and a plurality of mobile devices 140. The network operations center 110 can include one or more receivers (not shown) configured to receive content from one or more content providers 120. In some implementations, the receivers can reside at the network operations center 110. For example, the network operations center 110 can include a C-band receiver configured to receive content delivered by a C-band satellite content provider 120. In other implementations, the receivers can be located remotely from the network operations center 110 and can deliver the received content to the network operations center 110 using wired or wireless technology. The content received from the one or more content providers 120 can include local and national content. The local and national content can include real-time, non-real-time and IP data services content.

The real-time content can be received from C-band and Ku-band satellites, terrestrial broadcast transmitters, and data networks, in addition to other such transmitting devices and networks. The real-time content can include video, such as MPEG-2 over asynchronous serial interface, or YUV over serial digital interface. The real-time content also can include audio, such as AC-3 or MP2 over ASI, as well as PCM over SDI. Additionally, real-time content formatted in NTSC and PAL technologies can be delivered to the network operations center 110. Real-time MediaFLO™ content and services can be implemented to bring television experiences, similar to those experienced on a traditional television, to a mobile device. For example, the television experiences can include general entertainment programming, such as live sporting events, news, music concerts, and weather updates.

Similarly, non-real-time content formatted in MPV, such as MPEG-4 audio and video clips, and data services via Clipcast (DSvC), such as JPEG, PNG and HTML files, also can be received at the network operations center 110. The network operations center 110 can process the non-real-time content and can schedule network delivery of the content to one or more mobile devices. MediaFLO™'s non-real-time content and file delivery can extend the user experience to include short clips, e.g., YouTube™ videos, and files of non-real-time content, e.g., stored audio files.

In addition, MediaFLO™ can be implemented to deliver IP data services content, such as stock tickers, weather and news updates to the network operations center 110. The IP data services content can include a broad range of information accessible to each MediaFLO™ subscriber. In some implementations, the IP data services content can be tailored to a user's specific profile. For example, a MediaFLO™ subscriber can choose to receive particular IP data services content, such as weather and sports scores, at their MediaFLO™ compatible mobile device. Both the non-real-time and IP data services content can be delivered to the network operations center 110 over one or more data networks.

In some implementations, the network operations center 110 can aggregate the content received from the one or more content providers 120. In some implementations, the network operations center 110 can include additional content, such as locally stored content in the multiplexed content data stream. The aggregated content can be multiplexed at the network operations center 110 and distributed as a content data stream to one or more FLO transmitters 130. The one or more FLO transmitters 130 can receive the multiplexed content data stream from the network operations center 110. Based on the multiplexed content data stream, the FLO transmitters 130 can generate one or more FLO waveforms. The one or more FLO waveforms can be transmitted to one or more mobile devices 140.

Text, graphical and video content received from the FLO transmitters 130 can be displayed on a display screen at the mobile device 140. Audio content received from the FLO transmitters 130 can be played back at one or more audio outputs at the mobile device 140. The mobile device 140 can include an external and internal memory module that can store the received content. In some implementations, the mobile device 140 can communicate with the network operations center 110 over a reverse link, such as the wireless network 150. The reverse links can be used to communicate information for mobile device 140 activations, service key distribution, subscriptions, and usage tracking

### MediaFLO™ System Logical Architecture

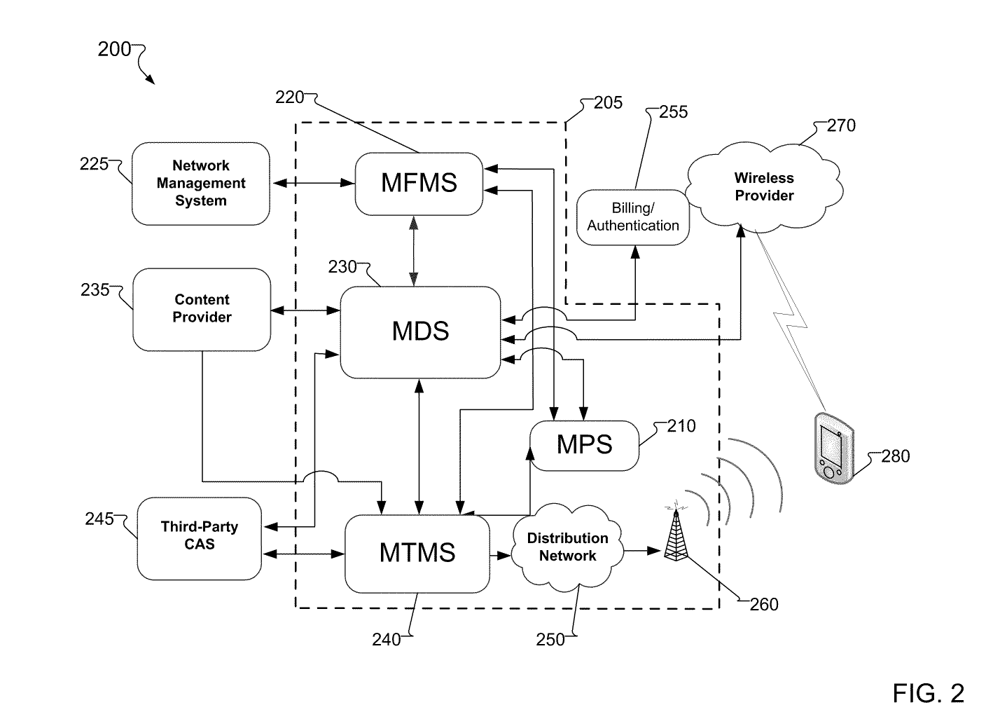

FIG. 2 illustrates an exemplary MediaFLO™ system logical architecture 200. The MediaFLO™ system logical architecture 200 includes one or more systems, subsystems, and components, a subset of which constitute a MediaFLO™ network 205. The MediaFLO™ network 205 generally comprises a MediaFLO™ Provisioning System (MPS) 210, a MediaFLO™ Management System (MFMS) 220, a MediaFLO™ Distribution System (MDS) 230, and a MediaFLO™ Transcode and Multiplex System (MTMS) 240. The MediaFLO™ network 205 may be implemented in the network operations center 110 depicted in FIG. 1. The MediaFLO™ network 205 also includes a FLO Radio Access Network (RAN) subsystem, comprising the MTMS 240, a distribution network 250 and one or more FLO transmitters 260. The MediaFLO™ network 205 can be implemented to deliver real-time, non-real-time and IP data services content to one or more mobile devices, such as a MediaFLO™ device 280.

The MPS 210 provides one or more interfaces for an operator to configure the MediaFLO™ network 205. The MPS 210 distributes the MediaFLO™ network 205 configuration to the various systems, subsystems, and components included in the MediaFLO™ network 205. In some implementations, the MPS 210 can provide one or more web services programming interfaces. Web and software developers can generate custom web services applications through the web service programming interface. For example, a MediaFLO™ developer using the MPS 210 programming interface can generate and offer custom subscription packages to MediaFLO™ subscribers. In addition, the MPS 210 can share data and information, i.e., transmit to and receive from, with the MFMS 220, the MDS 230, and MTMS 240.

The MFMS 220 performs the operations, administration and maintenance functions for the MediaFLO™ network 205. Specifically, the MFMS 220 can monitor the systems constituting the MediaFLO™ service platform, i.e., the MPS 210, the MDS 230, and the MTMS 240. Components outside the MediaFLO™ service platform can be monitored by other systems, subsystems, or components. The MFMS 220 can provide management interfaces to enable network, state, fault, security, performance, and log management within the MediaFLO™ network 205. Network management can include discovering new networks and nodes to monitor, deleting monitored nodes, controlling MediaFLO™ agents and components, such as reset counters, restarting components, and terminating components. For example, the MFMS 220 network management interface can be used to communicate with and control the network management system 225. The network management system 225 can be implemented to manage the MediaFLO™ network 205 within, or external to, the MediaFLO™ network 205.

State management can include monitoring the high availability state of MediaFLO™ components, managing the administrative state of MediaFLO™ components, and monitoring the operational state of MediaFLO™ components. Fault management can include managing events, alarms and alarm maps, as well as performing fault recovery. For example, a network operator can clear one or more alarms using a client interface associated with the fault management server component of the MFMS 220. Security management can include controlling operator access to the element management system and fault management system. Performance and log management can include collecting statistics from MediaFLO™ components, providing threshold-based monitoring, and providing reports and graphical views for the Key Performance Indicators (KPI) generated from the statistics. KPIs can be derived from the statistics and can define and measure progress toward organizational goals. In addition, the MFMS 220 can share data and information with the MDS 230 and the MTMS 240.

The MDS 230 provides efficient distribution of encrypted content across one or more wireless networks. The wireless networks can include data optimized (DO) networks, DO-multicast networks, 3G or 4G networks and FLO networks. The MDS 230 can maintain responsibility for aggregation and distribution of real-time content, non-real-time content, IP data services content, subscription services management and FLO resource scheduling. Additionally, the MDS 230 can be implemented to perform configuration management for the MediaFLO™ network 205. The MDS 230 also can include one or more of the following subsystems: distribution; digital rights management (DRM); subscription, billing and service management; unicast request handling; and usage tracking

The MDS 230 distribution subsystem interfaces with one or more content providers 235 to receive real-time, non-real-time, and IP data services content from the one or more content providers 235. The MDS 230 functions to provide a single user interface for streaming, Clipcast, and IP data services content. In some implementations, the MDS 230 distribution subsystem manages files, clips, and data content delivery. The distribution subsystem may also receive and consolidate program guide data from the content provider 235 and other sources, e.g., Tribune Media Services. The consolidated guide is termed a MediaFLO™ Program Guide (MPG) and can be implemented as an easy to use guide that contains program description and file delivery information associated with MediaFLO™ end users. The MDS 230 distributes the content, the MPG, and subscription information to one or more mobile devices using a FLO transmitter 260 or via a wireless provider 270.

The MDS 230 also can generate system information, such as overhead information, and can initiate distribution of the overhead information. In addition, the distribution subsystem can receive Clipcast content from content providers and can schedule clip delivery to mobile devices, such as a MediaFLO™ device 280, during contact windows. The distribution subsystem also can encrypt content for conditional access and apply forward-error-correction (FEC) encoding to improve reception probability at the MediaFLO™ device 280. Additionally, the distribution subsystem can be implemented to deliver content based on a network, or content provider, delivery schedule.

The MDS 230 DRM subsystem can distribute encryption keys to MediaFLO™ network 205 components. In addition, the DRM subsystem can securely distribute decryption keys to one or more MediaFLO™ devices 280. The DRM subsystem also can synchronize with one or more the third-party CAS 245. Third-party CAS 245 can provide protection of services on a per-user basis. For example, a third-party CAS 245 can blackout specific programs in certain regions, or restrict content available to a particular market.

The MDS 230 subscription, billing and service management (SBSM) subsystem can be implemented to make subscription-based billing predictable and readily understood. The SBSM subsystem can manage and provide MediaFLO™ content subscription packages. For example, the SBSM subsystem can provide subscription services and a back-end billing interface 255 for the MediaFLO™ network 205. The back-end billing interface 255 can include billing and authentication information, in addition to authorization and accounting functions. Additionally, the SBSM subsystem can provide MediaFLO™ service management and can generate new and custom subscription packages. The SBSM subsystem can receive subscription information from one or more mobile devices. In some implementations, the SBSM subsystem can activate MediaFLO™ services for one or more subscribing mobile devices.

The MDS 230 unicast request handling subsystem can be implemented to manage functions related to unicast device-to-server interface protocols. The unicast request handling subsystem includes a unicast configuration server (UCS) and a usage tracking service request handler (UTSRH). The UCS can receive provisioned application upgrade information sent from the MPS 210. In some implementations, the MPS 210 maintains all application version information, whereas the UCS only maintains the latest application version information. The MediaFLO™ device 280 generally receives application upgrade notifications via, e.g., a multicast notification delivery path from the wireless provider 270. However, when the MediaFLO™ device 280 application version is out-of-date, the MediaFLO™ device 280 can perform an application upgrade check via a unicast connection to the UCS to obtain the latest version information. The UTSRH can collect service usage and performance statistics from MediaFLO™-enabled mobile devices. For example, the MediaFLO™ device 280 can be instructed to log usage events and upload the logged usage tracking statistics to the UTSRH. The UTSRH can collect the usage tracking statistics from the MediaFLO™ device 280 and can forward the usage tracking log to the usage tracking subsystem. In some implementations, usage tracking parameters can be transmitted to the MediaFLO™ device 280 as part of the notification flow. The MediaFLO™ device 280 can decide what events to log and when to log the usage tracking statistics based on the usage tracking parameters.

The MDS 230 usage tracking subsystem can receive the MediaFLO™ device's 280 upload data from the UTSRH and can log the data in persistent storage. In some implementations, the usage tracking subsystem can collect upload data directly from the one or more MediaFLO™-enabled mobile devices. The usage tracking subsystem can be implemented to share at least a portion of the usage tracking statistics with one or more third-party entities. In some implementations, the third-party entities can use the usage tracking statistics to measure MediaFLO™ users' service usage patterns. In addition, the MDS 230 can share data and information with the MTMS 240.

The MTMS 240 can be implemented to receive content from one or more content providers 235. The content can include real-time, non-real-time and IP data services content. The MTMS 240 can aggregate the received content and can change the content into a format supported by one or more mobile devices. In some implementations, the MTMS 240 can encode the content received from the one or more content providers 235. For example, real-time, non-real-time and IP data services content can be aggregated and transcoded at the MTMS 240 for delivery to the MediaFLO™ device 280. The MTMS 240 also can multiplex the received content before delivering encoded and multiplexed content to a distribution network 250. In some implementations, a multiplexer component of the MTMS 240 can aggregate the received content and alter the content into a MediaFLO™ supported format. Additionally, in some implementations, the multiplexer component can include a statistical multiplexer (Stat-MUX) that can be configured to change the bit rate of services according to the needs of different channels at different times. In statistical multiplexing, a communication channel can be divided into an arbitrary number of variable bit rate digital channels or data streams. The Stat-MUX can employ a more complex method of managing change in input channel bit rates, which can result in a better utilization of bandwidth. For example, using the Stat-MUX, a MediaFLO™ network 205 operator can decrease the bit rate for generally static channel programming, like a newscast, while increasing the bit rate for more dynamic channel programming, like a basketball game. The MTMS 240 also can be implemented to encrypt content, in addition to determining resource allocation and distribution of content. Moreover, the MTMS 240 can communicate with one or more third-party CAS 245. In addition, the MTMS 240 can transmit data and information through the distribution network 250 to the FLO transmitter 260.

The distribution network 250 can receive encoded content from the MTMS 240 and can distribute the content to the one or more FLO transmitters 260. The FLO transmitter 260 can receive encoded content from the MTMS 240 over the distribution network 250. The encoded content can include content belonging to a wide-area operational infrastructure (WOI) and a local-area operational infrastructure (LOI). Generally, the WOI content is associated with a wide-area broadcast signal that will be transmitted over a larger broadcast area than the LOI content, which is associated with a local-area broadcast signal. For example, the WOI content may be national news, and the LOI content may be regional or local news. The WOI and LOI content can be received by the FLO transmitter 260 in distinct WOI and LOI signals, or in one or more combined signals. The FLO transmitter 260 can be implemented to transmit the WOI content, the LOI content, or both, as a mobile broadcast signal to one or more mobile devices. The FLO transmitter 260 can supply the content to MediaFLO™-enabled mobile devices by transmitting a FLO waveform. For example, the FLO transmitter 260 can transmit a FLO waveform including the WOI and LOI content to the MediaFLO™ device 280.

In some implementations, the FLO transmitter 260 also can transmit content particular to a specific venue, or micro-venue. The content particular to the specific venue or micro-venue can be received from the MTMS 240 over the distribution network 250. Venues can include, e.g., sporting arenas, concert halls, movie theatres, shopping malls, or other such event locations. For example, the FLO transmitter 260 can transmit player statistics associated with a baseball game to MediaFLO™-enabled mobile devices residing within the confines, or surrounding area, of a baseball stadium. Micro-venues can include, e.g., office buildings, automobiles or other mobile objects, restaurants, shopping mall department stores or kiosks, or other more localized event locations. For example, the FLO transmitter 260 can transmit sale-related data to users operating MediaFLO™-enabled mobile devices within the confines, or surrounding area, of a department store. Additional information related to venue and micro-venue broadcasting can be found in U.S. patent application Ser. No. 12/569,792, filed Sep. 29, 2009, entitled “Apparatus and Methods of Providing and Receiving Venue Level Transmissions and Services,” the entire contents of which are incorporated by reference herein.

The FLO transmitter 260 can include an exciter component and a transmitter component. The exciter component can receive ASI MPEG-2 transport streams and can perform proportional-integral-derivative (PID) filtering for the desired multiplex. The exciter component also can generate low power, e.g., less than 1-watt, FLO waveforms for the transmitter input. The transmitter component can generate RF signals that can be received over an air interface by one or more mobile devices. In some implementations, the transmitter can generate and transmit a FLO waveform using orthogonal frequency division multiplexing (OFDM). The transmitter also can be implemented to deliver RF signals to the MediaFLO™ device 280 via broadcast, multicast and unicast methodologies.

In some implementations, the MTMS 240, the distribution network 250 and the

FLO transmitter 260 comprise the FLO RAN subsystem. The FLO RAN subsystem can receive real-time, non-real-time and IP data services content, and can perform audio and video encoding. The FLO RAN subsystem also can multiplex the received content and can distribute the multiplexed data streams. For example, the FLO RAN subsystem can receive real-time content, encode it, and multiplex it with other services, e.g., IP data services or DSvC, before encapsulating and distributing the content to FLO transmitters 260. Additionally, the FLO RAN subsystem can transmit one or more FLO waveforms to one or more mobile devices. For example, the FLO transmitter 260 of the FLO RAN subsystem can transmit one or more FLO signals to the MediaFLO™ device 280. The MediaFLO™ device 280 can be implemented to demodulate the FLO RF signal. Users operating the MediaFLO™ device 280 can navigate through each of the MediaFLO™ supported services and can access content received at the device. In addition, MediaFLO™ device 280 users can perform transaction-oriented operations with the MDS 230 over unicast connections through the wireless provider 270.

### Floating and Fixed Time Merchandising and Access Control

The techniques disclosed below illustrate mechanisms for enabling floating and fixed time merchandising and access control in a mobile broadcast network and in associated user devices. By enabling floating and fixed time merchandising options, users of the user devices may purchase subscription packages that better suit their individual needs. A floating time subscription package enables a user to access content for a specific duration. For example, a user may purchase a subscription package that enables access to a children's television package for 24 hours beginning at the time of purchase. A fixed time subscription package enables a user to access content between a defined start and end time. For instance, a user may purchase a subscription package that enables access to a sports television package between 12 p.m. and 1 p.m., regardless of when the user purchased the subscription package.

### First Floating and Fixed Time Merchandising and Access Control Architecture

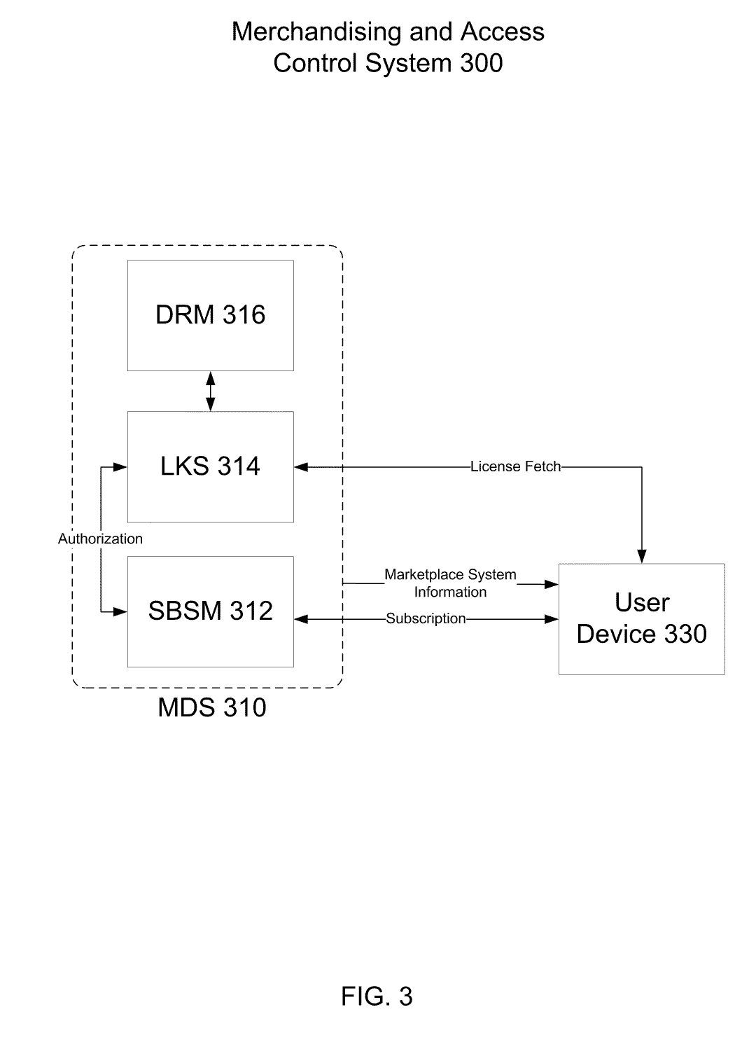

FIG. 3 illustrates a first exemplary architecture for a merchandising and access control system 300 configured to provide support for floating and fixed time merchandising. In some implementations, the functions provided by the components of the merchandising and access control system 300 are implemented in fewer components or more components (not shown) than the components illustrated in FIG. 3. For example, the merchandising and access control system 300 may use any suitable component or components of the MediaFLO™ system logical architecture 200 shown in FIG. 2.

In certain implementations, the merchandising and access control system 300 includes an MDS 310 and one or more user devices 330.

The MDS 310 is similar to the MDS 230 shown in FIG. 2. The MDS 310 may provide, for example, efficient distribution of encrypted content across one or more wireless networks to the user device 330. Wireless networks can include data optimized (DO) networks, DO-multicast networks, 3G or 4G networks, and FLO networks. In some implementations, the MDS 310 may distribute content and marketplace system information to the user device 330. Marketplace system information may include information regarding service packages and associated subscription packages. In certain implementations, subscription packages may include floating and/or fixed time subscriptions.

In certain implementations, the MDS 310 can include one or more of the following subsystems: subscription, billing and service management (SBSM) 312, license key server (LKS) 314, and digital rights management (DRM) 316.

The SBSM subsystem 312 can manage subscription packages. In some implementations, the SBSM subsystem 312 can include a subscription request handler component (SRH) (not shown). The SRH may handle subscription requests received from the user device 330. The SRH can further store subscription related information for the user device 330 in persistent subscription storage. The SRH can additionally send a response to the user device 330 indicating the success or failure of a subscription request. Subscription requests may include subscription package information for service packages to which a user operating the user device 330 wants to subscribe. Subscription requests may, in addition or in the alternative, include subscription package information for service packages from which a user operating the user device 330 wants to unsubscribe. In some implementations, subscription requests may include information regarding floating and/or fixed time subscription packages.

The LKS 314 can receive and manage service license requests received from the user device 330. The LKS 314 may additionally distribute encrypted service keys to the user device 330. In some implementations, the encrypted service keys may include service key lifetime information and service key lifetime signatures.

The DRM subsystem 316 can generate encrypted service keys for one or more services. Service keys may be used to decrypt and gain access to service content. In some implementations, the DRM subsystem 316 may additionally generate service key lifetime signatures for fixed and floating time subscriptions. The service key lifetime signatures may be used to verify the service key lifetime information for one or more services.

The user device 330 can include or be any suitable device for communicating with the MDS 310. User device 330 may be any suitable device including a cellular phone, a smartphone, a personal digital assistant (PDA), a pager, a laptop computer, a desktop computer, a tablet device, a computing device integrated into a vehicle, and the like. The user device 330 may include a computer-readable medium (CRM) and a processor that is coupled to the CRM (both not shown). The user device 330 may further include a conditional access system (CAS) component (not shown) for validating lifetime signatures and enforcing access to service content constrained to lifetime information defined by a service key. The CAS component may be embodied on the CRM.

### First Implementation: Process for Floating and Fixed Time Merchandising and Access Control

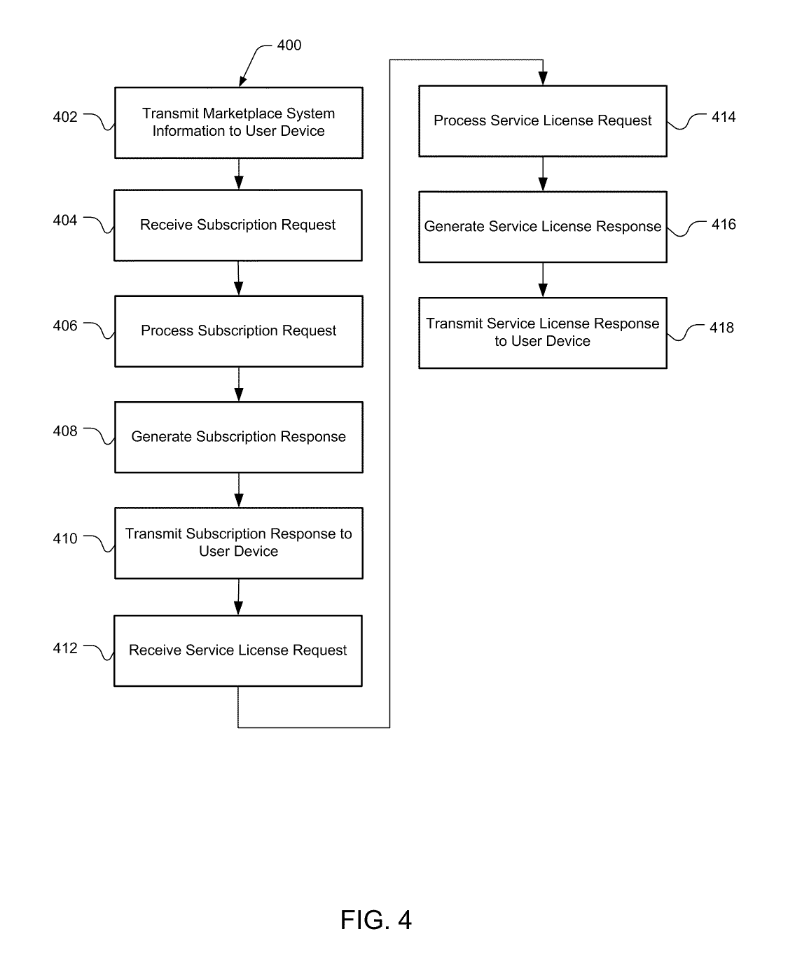

Referring to FIG. 4, a process 400 for providing floating and fixed time merchandising and access control using the merchandising and access control system 300, according to a first implementation, includes the stages shown. The process 400 is exemplary only and not limiting. The process 400 can be altered in any suitable manner (e.g., by having stages added, removed, or rearranged).

In certain implementations, communication between the MDS 310 and the user device 330 may be performed according to a device-to-server interface protocol, such as a unicast device-to-server interface protocol. For example, in some implementations, messages exchanged between the MDS 310 and the user device 330 may be generated according to a device-to-server interface protocol. As another example, request and response messages exchanged between the MDS 310 and the user device 330 may additionally be transmitted according to a device-to-server interface protocol.

At stage 402, the MDS 310 transmits marketplace system information to the user device 330. The marketplace system information may include relevant data regarding one or more available service packages. In particular, the marketplace system information may include package records that describe the one or more available service packages. For example, the marketplace system information may include a package record describing a sports television package that is available for access by the user device 330.

In certain implementations, a package record may define one or more subscription packages for an available service package. Each defined subscription package or subscription option may describe access parameters for the available service package. For example, a subscription package may define the parameters (e.g., price, timing information, etc.) for monthly recurring access to a sports television package.

In some implementations, a package record may define floating and/or fixed time subscription packages for an available service package. For example, a package record may define an hourly floating subscription package for a sports television package. The package record may additionally define a weekly floating subscription package for the same sports television package. Purchasing the hourly floating subscription package would permit a user device to access the sports television package for an hour. Likewise, purchasing the weekly floating subscription package would permit a user device to access the sports television package for a week. In some implementations, a package record may be created by an MPS (e.g., the MPS 210 of FIG. 2) in communication with the MDS 310.

Data of a package record describing floating and fixed time subscription packages may include subscription method information, time multiple information, start time information, and end time information.

Subscription method information may indicate a subscription type for a particular subscription package. For example, the subscription method data may define a subscription package as a recurring, fixed, hourly floating, daily floating, weekly floating, or monthly floating type. It should be appreciated that the aforementioned list is merely exemplary and that subscription packages may be of any suitable type.

Time multiple information may define a multiplier value for a time unit provided by the subscription method information, where the subscription method information indicates a floating type subscription package. For example, the subscription method of a floating time subscription package may indicate that the subscription is of the hourly floating type. An associated time multiple may further indicate a multiplier value of 3. As a result, a user device that purchases the subscription package would receive access to services associated with the service package for a period of three hours (i.e., one hour multiplied by 3).

Start time and end time information may define a period for which access to a service package is permitted. For example, a fixed time subscription package for a football game event may include a start time of 1 p.m. and an end time of 5 p.m. As a result, a subscribed user device would only have access to the football game event within the aforementioned time period. In some implementations, start time and end time information may only be provided for fixed time subscription packages.

In certain implementations, the marketplace system information transmitted from the MDS 310 to the user device 330 may be locally cached on the user device 330. In some implementations, the user device 330 may generate a GUI based on the marketplace system information. The GUI may allow a user to select the subscription packages that he or she wishes to purchase. The GUI may additionally allow the user to select the subscription packages from which he or she wishes to unsubscribe.

Referring to FIG. 4, at stage 404, the SBSM subsystem 312 of the MDS 310 receives a subscription request to subscribe to and/or unsubscribe from one or more subscription packages. In some instances, the request may be transmitted from the user device 330. For example, a user may interact with the GUI provided by the user device 330 to select one or more subscription packages to subscribe to and/or unsubscribe from. In response, the user device 330 may generate and transmit a subscription request to the SBSM subsystem 312. As another example, a user may switch a SIM card or similar identification device from a first user device to a second user device (e.g., upgrade to a new mobile device). As a result, the second user device may generate and transmit a subscription request to the SBSM subsystem 312 in order to have the user's subscription packages activated for the second user device. In other instances, a subscription request may be received from a customer service representative acting on behalf of a user. For instance, a user may call a customer service representative and indicate that he or she wishes to subscribe to or unsubscribe from one or more subscription packages. The customer service representative may thereafter cause a subscription request to be generated and transmitted to the SBSM subsystem 312 by using, for example, a desktop computer. As another example, a user may switch from using a first user device to a second user device. The user may thereafter call a customer service representative and request to have the user's subscription packages activated for the second user device. The customer service representative may subsequently cause a subscription request to be generated and transmitted to the SBSM subsystem 312.

A subscription request may include any relevant information for subscribing and/or unsubscribing a user device from one or more subscription packages. For example, a subscription request may include a subscriber identifier, a subscribe list including package records for subscription packages to which a user device is subscribing, an unsubscribe list including package records for subscription packages from which a user device is unsubscribing, and the like. In some implementations, the subscribe and unsubscribe lists may include package records that include service package identification data, such as package identifiers, package versions, and the like.

In some implementations, the subscribe and unsubscribe lists may include information for floating and fixed time subscription packages. For example, the package records included in the subscribe and unsubscribe lists may include subscription method information, time multiple information, start time information, end time information, and the like. Illustratively, a subscribe list may include a package record with information indicating that a user wishes to subscribe to a fixed time subscription package that permits access to a football game event from 1 p.m. to 5 p.m. In some implementations, the start time and end time information, unlike in the marketplace system information, may also be provided for non-fixed time subscription packages.

In certain implementations, the subscribe and unsubscribe lists may include package records with identical package identifiers. However, the package records may further include distinct start and end times. Such information (e.g., identical package identifiers paired with distinct start and end time information) would indicate a renewal subscription scenario. For example, a subscribe list may indicate that a user wishes to subscribe to a floating sports television package for an hour on Tuesday and for another hour on the following Thursday.

In certain implementations, the subscription request may include a digital signature that may be used to authenticate the request. The digital signature may be signed by the user device 330 using any suitable device authentication key.

Referring to FIG. 4 at stage 406, a processor in the SBSM subsystem 312 processes the subscription request to allow the user device 330 to be subscribe to and/or unsubscribe from the one or more subscription packages identified in the request. In certain implementations, processing a subscription request may include, among other processes, authentication and authorization. For example, the SBSM subsystem 312 may determine the authenticity of a subscription request by verifying a digital signature provided in the request. As a second example, the SBSM subsystem 312 may determine whether the user device 330 is authorized to subscribe to and/or unsubscribe from the one or more subscription packages identified in the request.

At stage 408, the processor in the SBSM subsystem 312 generates a subscription response. The generated subscription response may include a copy of a subscription profile associated with the user device 330. The subscription profile may identify the subscription packages to which the user device 330 is currently subscribed and/or the subscription packages from which the user device 330 is currently unsubscribed. The subscription profile may further include information for floating and fixed time subscriptions. For example, the subscription profile may include subscription method information, time multiple information, start time information, end time information, and/or the like. In some implementations, the start time and end time information, unlike in the marketplace system information, may also be provided for non-fixed time subscription packages.

At stage 410, the SBSM subsystem 312 transmits the generated subscription response to the user device 330. The user device 330 may, in turn, generate and send a service license request to the LKS 314 of the MDS 310.

At stage 412, the LKS 314 receives a service license request from the user device 330. Upon receiving the service license request, a processor in the LKS 314 may begin processing the service license request at stage 414. Processing performed by the LKS 314 may include transmitting an authorization service request to the SBSM subsystem 312. The authorization service request may include information for identifying the user device 330, including a subscriber identifier, a device identifier, and/or the like.

Upon receiving the authorization service request, the SBSM subsystem 312 may determine a list of subscribed services associated with the user device 330. For example, the SBSM subsystem 312 may access a database and retrieve a subscription profile associated with the user device 330 in order to determine the list of subscribed services.

The SBSM subsystem 312 may additionally determine one or more subscription lifetime periods for each service in the list that is subscribed via a time-based (e.g., floating/fixed time) subscription package.

In certain implementations, the SBSM subsystem 312 may determine that a service has one subscription lifetime period where the user device 330 is subscribed to the service via only a single time-based subscription package. For example, if a service is subscribed via a single hourly floating subscription package, the SBSM subsystem 312 would determine that the service has a subscription lifetime period of one hour.

In some implementations, the SBSM subsystem 312 may determine that a service has one subscription lifetime period where the user device 330 is subscribed to the service via multiple subscription packages with intersecting or continuous access periods. The SBSM subsystem 312 would determine that the subscription lifetime period covers the union of the subscription packages' access periods. Illustratively, a user device may be subscribed to a service via three time-based subscription packages. The three subscriptions may have continuous access periods. In particular, the first subscription package may be a one day subscription for Monday. The second subscription package may be a one day subscription for Tuesday. The third subscription package may be a one week subscription beginning on Wednesday. Since the three subscription packages have consecutive access periods, the SBSM subsystem 312 would determine that the service has a single subscription lifetime period of nine days.

The SBSM subsystem 312 may additionally determine that a service has multiple subscription lifetime periods where the user device 330 is subscribed to the service via multiple subscription packages with disjoint access periods. Illustratively, a user device may be subscribed to a service via three time-based subscription packages. The three subscription packages may further have non-intersecting access periods. For instance, the first subscription package may be a one day subscription for Monday. The second subscription package may be a one day subscription for Wednesday. The third subscription package may be a one hour subscription for Friday. Since the three subscription packages do not have intersecting access periods, the SBSM subsystem 312 would determine that the service has three separate subscription lifetime periods.

Upon determining a list of subscribed services and any associated subscription lifetime periods, the SBSM subsystem 312 generates and transmits an authorization service response to the LKS 314. The authorization service response may include the list of subscribed services for the user device 330. The authorization service response may further include the subscription lifetime periods for the services subscribed to via time-based subscription packages. In some implementations, the subscription lifetime periods may be defined by start time and end time information. It should be noted that unlike the start time and end time information provided in the marketplace system information for just fixed time subscription packages, the start time and end time information defining the subscription lifetime periods may be provided for services subscribed to via both floating and fixed time subscription packages.

Upon receiving the authorization response, the LKS 314 generates an internal service license request. In certain implementations, the service license request includes a device version value. The device version value may indicate a hardware and/or software version for the user device 330. The internal service license request may further include information provided in the authorization response by the SBSM subsystem 312, including a list of subscribed services and any associated subscription lifetime periods. Upon generating the service license request, the LKS 314 may transmit the service license request to the DRM subsystem 316 of the MDS 310.

After receiving the service license request, the DRM subsystem 316 may generate an internal service license response. In generating a service license response, the DRM subsystem 316 may generate service keys for the subscribed services associated with the user device 330. A service key may be used to gain access to an associated service.

In some implementations, a service key may include service key lifetime information. The service key lifetime information may define the start and end times for which a service key is valid. In certain implementations, the service key lifetime information may be defined only for services subscribed via time-based subscription packages. The service key lifetime information may be based on a subscription lifetime period included in the internal service license request received from the LKS 314. In some instances, the service key lifetime information may define a duration equal to a subscription lifetime period for a service. In other instances, the service key information may define a duration that is a portion of a subscription lifetime period for a service.

In some implementations, a service key may further include a service key lifetime signature. The service key lifetime signature may be used to verify a service key's lifetime information. In some implementations, the DRM subsystem 316 may generate the service key lifetime signature using any suitable signing key. In some implementations, the service key lifetime signature may be a cryptographic signature. The service key lifetime signature may serve to protect the validity of the service key lifetime information.

In certain implementations, the DRM subsystem 316 may generate a service key for each subscription lifetime period associated with a subscribed service. For example, the user device 330 may be subscribed to a service via two floating time subscription packages with disjoint access periods. The first floating time subscription package may be for an hour on Tuesday. The second floating time subscription package may be for an hour on Thursday. As a result, the DRM subsystem 316 may generate two service keys for the subscribed service.

In some implementations, the DRM subsystem 316 may generate a service key for each epoch that overlaps with a subscription lifetime period associated with a subscribed service. An epoch indicates a period of time, apart from subscription timing information, for which one or more service keys are valid. Epochs are typically used so that service keys stored in a user device can be regularly changed over time. Regularly changing service keys reduces the possibility of prolonged, unauthorized service access.

As mentioned, a subscription lifetime period associated with a service may overlap with or straddle two or more consecutive epochs. In order to ensure that a user device is able to access a subscribed service for an entire subscription lifetime period, a service key is provided for each epoch that overlaps with the subscription lifetime period.

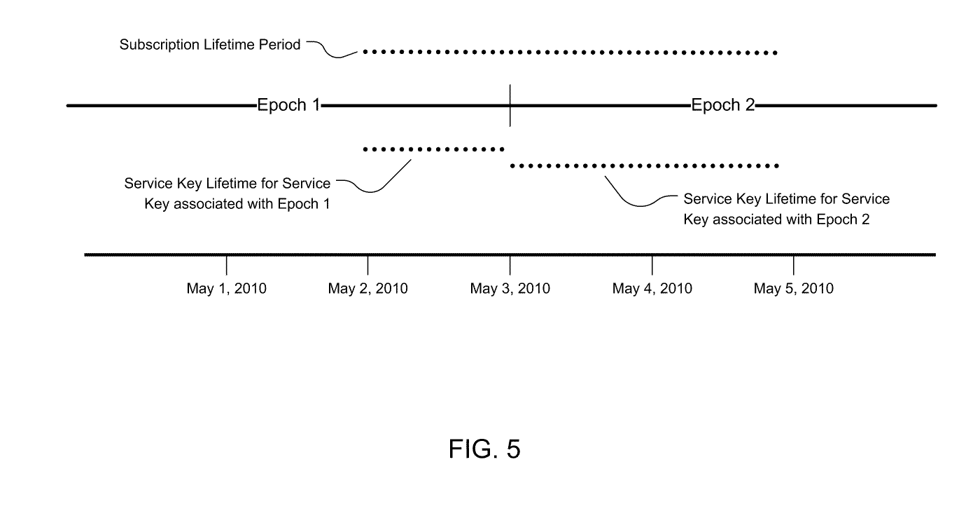

More specifically, a service key associated with a particular epoch may include service key lifetime information indicating a duration equal to the portion of an associated subscription lifetime period that overlaps with the epoch. Referring to FIG. 5, for example, a service may have a subscription lifetime period of three days starting from the beginning of May 2 until the end of May 4. The first day may overlap with a first epoch. The second and third days may overlap with a second epoch following the first epoch. As a result, the DRM subsystem 316 may provide a service key lifetime of one day for a service key associated with the first epoch. The DRM subsystem 316 may additionally provide a service key lifetime of two days for a service key associated with the second epoch.

In certain implementations, the DRM subsystem 316 may encrypt the generated service keys using any suitable encryption key.

After generating an internal service license response, the DRM subsystem 316 transmits the internal service license response to the LKS 314. After receiving the service license response, the LKS 314 may generate and transmit a service license response to the user device 330 at stages 416 and 418, respectively. In some implementations, the service license response may be substantially the same as the service license response received by the LKS 314 from the DRM subsystem 316.

After receiving the service license response, the user device 330 may provide access to a service using a service key included in the service license response. The user device 330 may further limit access to the service based on the service key lifetime information included in the service key. The user device 330 may additionally verify the authenticity of the start and end time information prior to permitting access to the service.

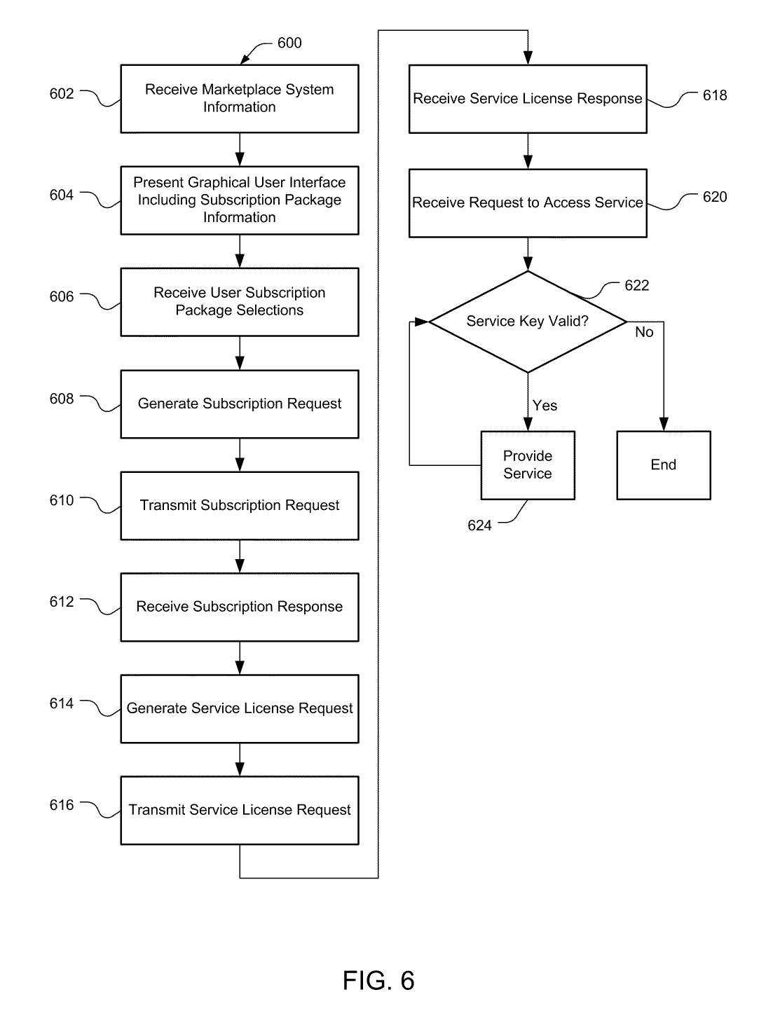

Referring to FIG. 6, a process 600, according to a first implementation, for handling fixed and floating time merchandising on a user device in the merchandising and access control system 300 includes the stages shown. The process 600 is exemplary only and not limiting. The process 600 can be altered in any suitable manner (e.g., by having stages added, removed, or rearranged).

In certain implementations, communication between the MDS 310 and the user device 330 may be performed according to a device-to-server interface protocol, such as a unicast device-to-server interface protocol. For example, in some implementations, messages exchanged between the MDS 310 and the user device 330 may be generated according to a device-to-server interface protocol. As another example, request and response messages exchanged between the MDS 310 and the user device 330 may additionally be transmitted according to a device-to-server interface protocol.

At stage 602, the user device 330 receives marketplace system information from the MDS 310. The marketplace system information may include relevant data regarding one or more available service packages. In particular, the marketplace system information may include package records that describe the one or more available service packages.

In certain implementations, a package record may define one or more subscription packages for an available service package. In some implementations, a package record may include data for defining floating and fixed time service subscription packages. In particular, a package record may include subscription method information, time multiple information, start time information, end time information, and the like. In certain implementations, marketplace system information may be locally cached on the user device 330.

At stage 604, the user device 330 generates a GUI for presenting information based on the marketplace system information. The GUI may provide, to a user, information regarding available subscription packages. For example, the user device 330 may generate a GUI including a subscriptions menu. The subscriptions menu may provide information regarding service subscription packages available for purchase.

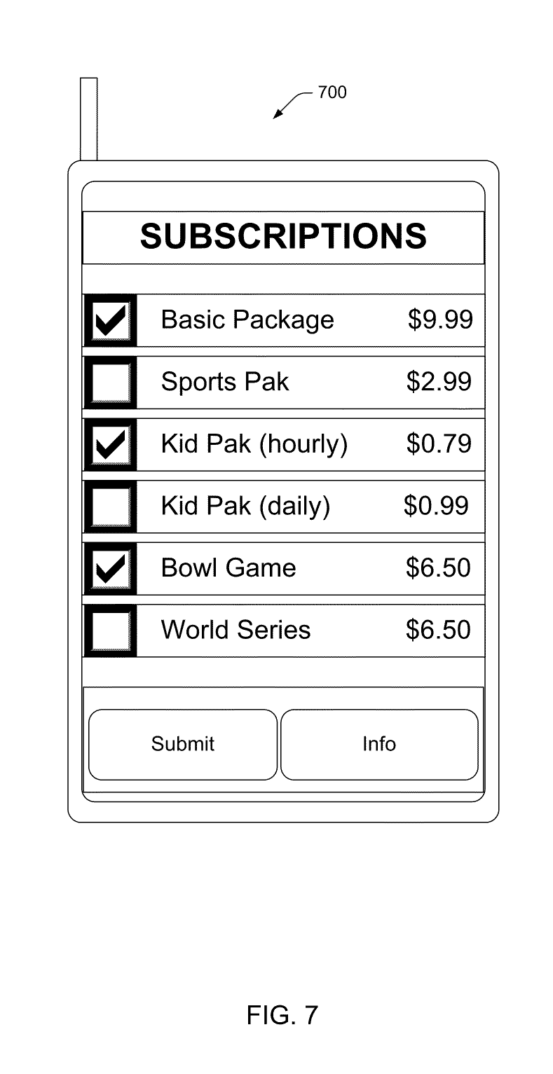

In some implementations, information provided by the GUI may indicate whether a particular subscription is a recurring, floating, or fixed time subscription. The GUI may further indicate timing information (e.g. access periods and/or start and end times), pricing, availability, and/or any other relevant information for a particular subscription package. FIG. 7 shows an exemplary GUI according to an implementation. As shown in FIG. 7, the subscriptions menu indicates six available subscription packages, timing information, and associated purchase prices. For instance, the subscriptions menu provides information regarding an available hourly floating time Kid Pak subscription package with a purchase price of $0.79.

At stage 606, the user device 330 receives a selection (e.g., from a user of the user device 330) of one or more service subscription packages, where the selection may be entered using the GUI, to request to subscribe to the selected subscription packages. In certain implementations, the user device 330 may additionally or alternatively receive selections of one or more service subscription packages, e.g., as entered using the GUI, to request to unsubscribe from the selected subscription packages. Upon confirming the selections, the user device 330 may generate a subscription request at stage 608.

At stage 610, the user device 330 transmits the subscription request to the SBSM subsystem 312 of the MDS 310. In some implementations, a subscription request may include any relevant information for subscribing to and/or unsubscribing from one or more service subscriptions. For example, a subscription request may include any relevant information for subscribing and/or unsubscribing a user device from one or more subscription packages. For example, a subscription request may include a subscriber identifier, a subscribe list including package records for subscription packages to which a user device is subscribing, an unsubscribe list including package records for subscription packages from which a user device is unsubscribing, and the like. In some implementations, the subscribe and unsubscribe lists may include package records that include service package identification data, such as package identifiers, package versions, and the like.

In some implementations, a subscription request may additionally include information for floating and fixed time subscriptions. For example, the subscribe and unsubscribe lists may include package records that include subscription method information, time multiple information, start time information, end time information, and the like.

In certain implementations, the subscribe and unsubscribe lists may include package records with identical package identifiers. However, the subscription package records may further include distinct start and end times. Such information would indicate a renewal subscription scenario. For example, a subscription request may indicate that a user wishes to subscribe to a floating sports package for an hour on Tuesday and for another hour on the following Thursday.

In certain implementations, the subscription request may include a digital signature. The digital signature may be signed by the user device 330 using any suitable device authentication key.

Upon receiving the subscription request, the SBSM subsystem 312 processes the subscription request. In certain implementations, processing may include authenticating and authorizing the subscription request. Upon successfully authenticating and authorizing a subscription request, the SBSM subsystem 312 generates and transmits a subscription response to the user device 330.

At stage 612, the user device 330 receives the subscription response. Upon receiving the subscription response, the user device 330 generates a service license request at stage 614. The service license request may include any relevant information including subscriber identifiers, device identifiers, and/or the like.

At stage 616, the user device 330 transmits the service license request to the LKS 314 of the MDS 310. Upon receiving the service license request, the LKS 314 processes the service license request and generates a service license response. In some implementations, processing of the service license request may include processing performed by other subsystems such as the SBSM subsystem 312 and the DRM subsystem 316 of the MDS 310.

In some implementations, the service license response generated by the LKS 314 may include encrypted service keys for one or more subscribed services. Service keys for services subscribed to via floating or fixed time subscription packages may include service key lifetime information. Service key lifetime information may include start time information and end time information. In some implementations, service keys may additionally include service key lifetime signatures. The service key lifetime signatures may be used to verify the service key lifetime information. In some implementations, one or more service keys may be provided for each subscription lifetime period associated with a service. In certain implementations, one or more service keys may be provided for each epoch that overlaps with a subscription lifetime period associated with a service, as described above.

At stage 618, the user device 330 receives the service license response from the LKS 314. Upon receiving the service license response, the user device 330 may authenticate the response. The user device 330 may also verify the start time and end time information provided by the service license response, e.g., by checking associated service key lifetime signatures. In certain implementations, a conditional access system (CAS) component of the user device 330 may verify and enforce the start time and end time information using the service key lifetime signatures.

At stage 620, the user device 330 receives a request (e.g., from the user operating the user device 330) to access a subscribed service. For example, a user may interact with a GUI provided by the user device 330 and select to watch an animated television program. In response, the user device 330 may determine if the user is authorized to access the subscribed service at decision 622, e.g., by selecting a service key associated with the subscribed service and determining if the service key is currently valid. In particular, the user device 330 may determine whether the service key is valid based on the service key's lifetime information. For example, the user device 330 may verify the service key's lifetime information using an associated service key lifetime signature. The user device 330 may additionally verify that the current time is within a period defined by the service key's start time and end time information. In certain implementations, a conditional access system (CAS) component of the user device 330 may verify the validity of a service key.

If the service key is determined not to be valid (the “no” branch of decision 622), access to the subscribed service is not permitted, and the process 600 ends. In some implementations, the user device 330 may additionally notify the user that access is not permitted.

If the user device 330 determines that the service key is valid (the “yes” branch of decision 622), access to the subscribed service is permitted at stage 624. For example, the user device 330 may begin displaying content associated with the subscribed service for consumption by the user. In certain implementations, access to a subscribed service may be stopped once it is determined that a service key is no longer valid. For example, the user device 330 may initially provide access to a subscribed service. During access, however, the user device 330 may determine that the current time falls outside the period defined by the start and end times for the service key. As a result, the user device 330 may determine that the service key is no longer valid at decision 622, and accordingly discontinue access to the subscribed service. In some implementations, the user device 330 may additionally notify the user that access is no longer permitted.

In certain implementations, the user device 330 may indicate to a user the remaining time for a subscription package. In some implementations, the user device 330 may notify a user that a subscription package is about to expire. For example, the user device 330 may provide a GUI including a pop-up message indicating the impending expiration of a subscription package. Once the user is notified, he or she can take steps to ensure continuous service, such as renewing his or her subscription package. In certain implementations, the user device 330 may determine whether a user is to be notified based on a threshold remaining time period. In some implementations, the threshold remaining time period may be any suitable fixed time period prior to expiration of a particular subscription package. For example, a threshold remaining time period may be five minutes, one hour, one day, and/or the like. In some implementations, the threshold remaining time period may differ based on the subscription type. For example, an hourly floating subscription may have a threshold remaining time period of 10 minutes. In contrast, a weekly floating subscription may have a threshold remaining time period of one day. In certain implementations, the threshold remaining time period may be determined based on a percentage of the total subscription package access period that remains prior to expiration. For example, the user device 330 may determine that a user is to be notified that a subscription package is about to expire when five percent of the total subscription access period remains.

### Device-to-Server Interface Protocols

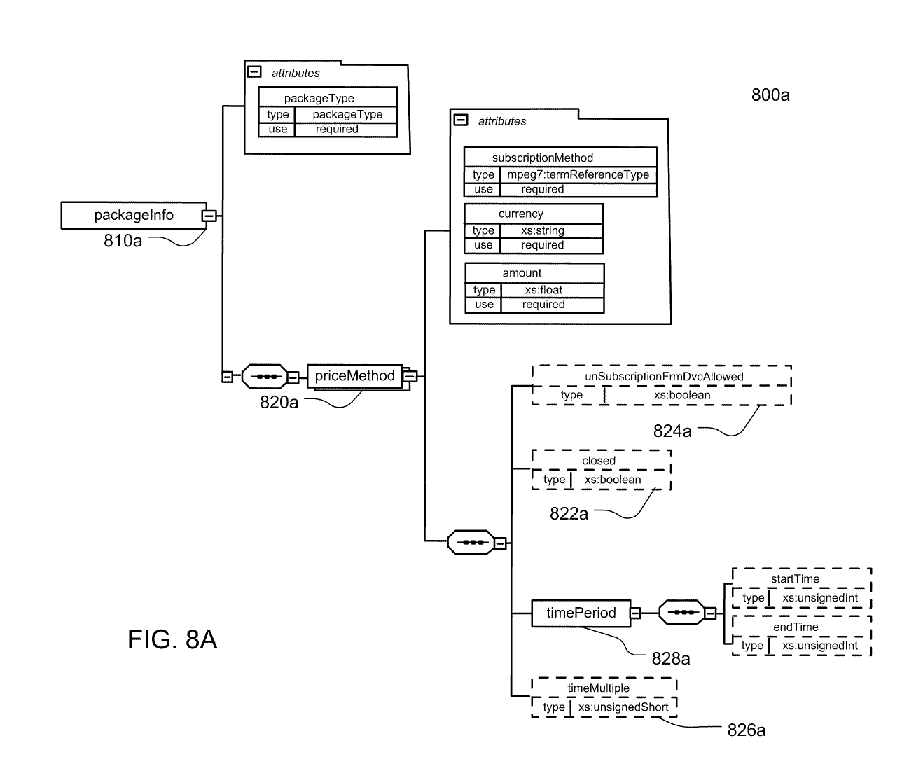

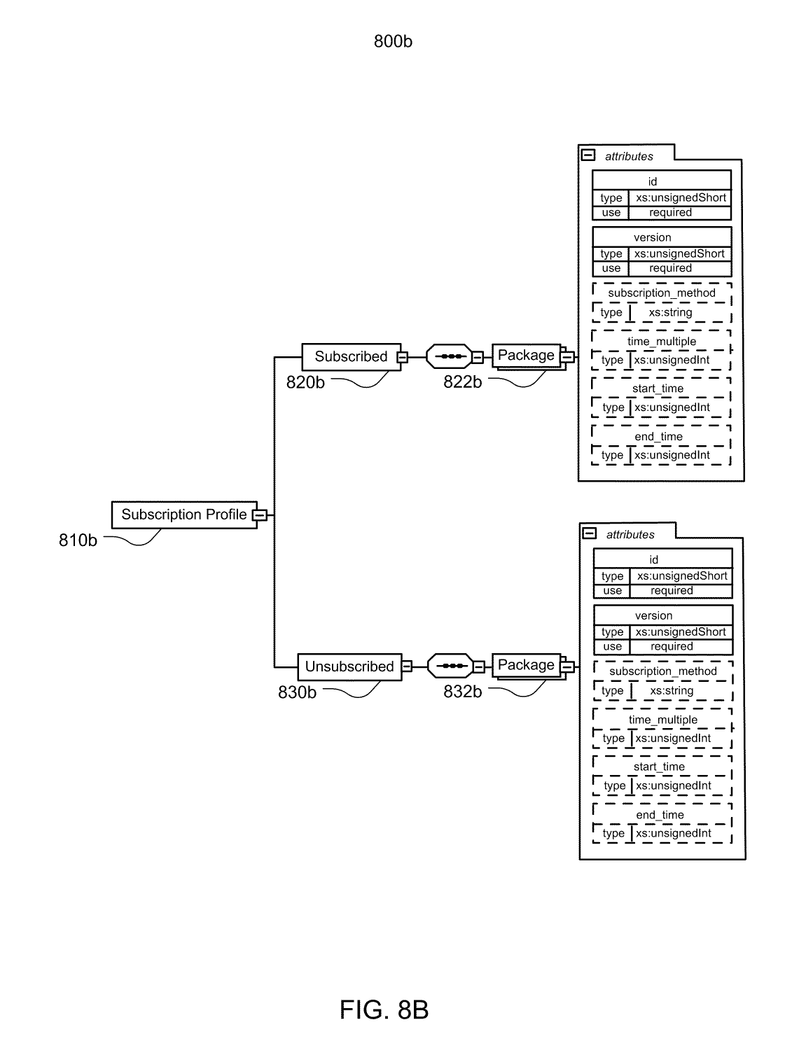

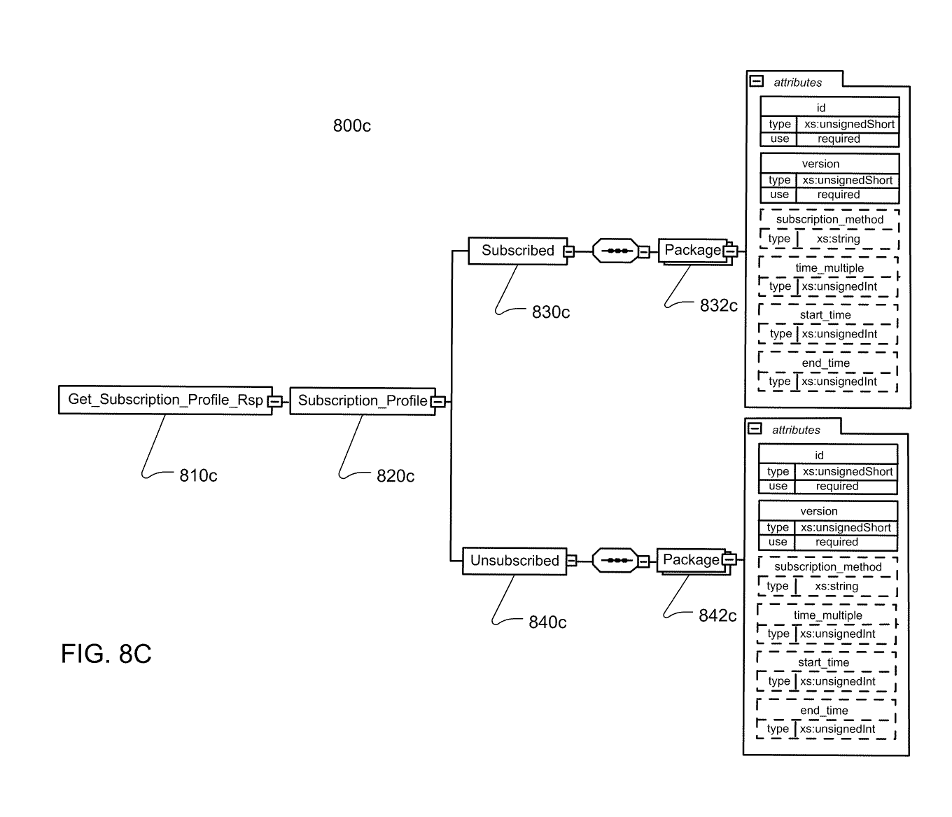

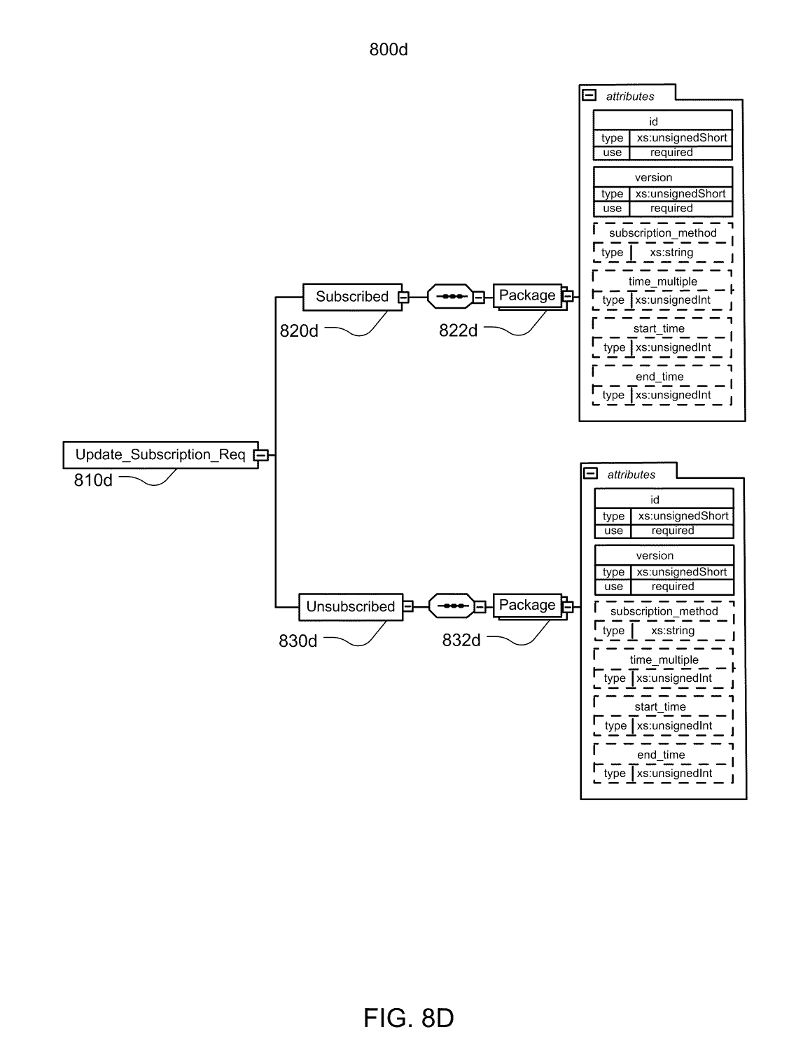

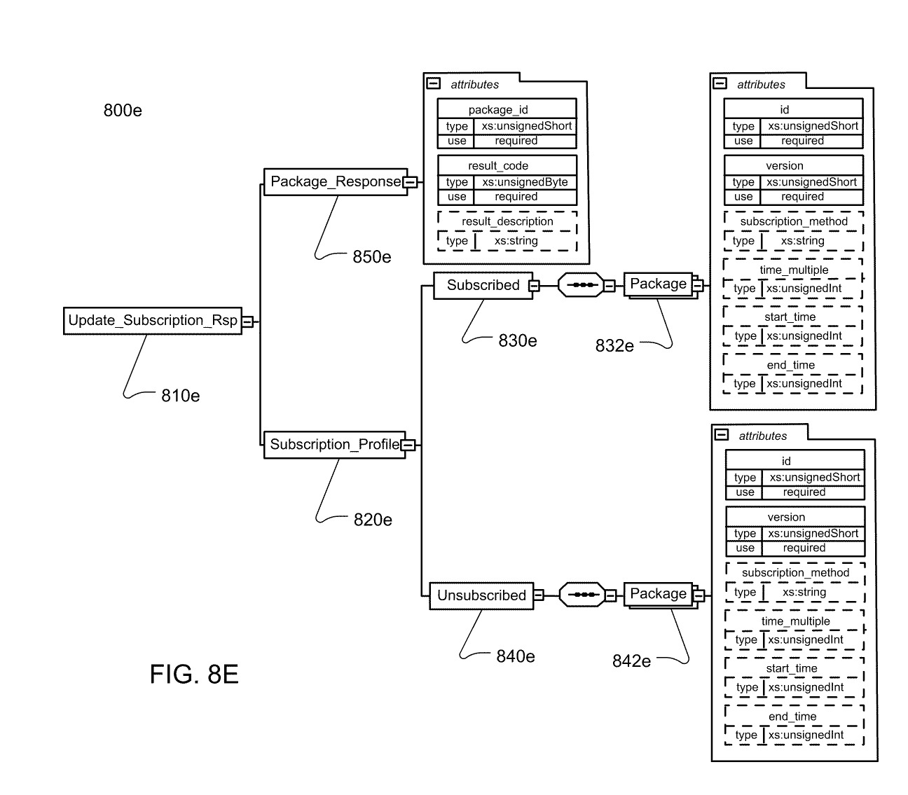

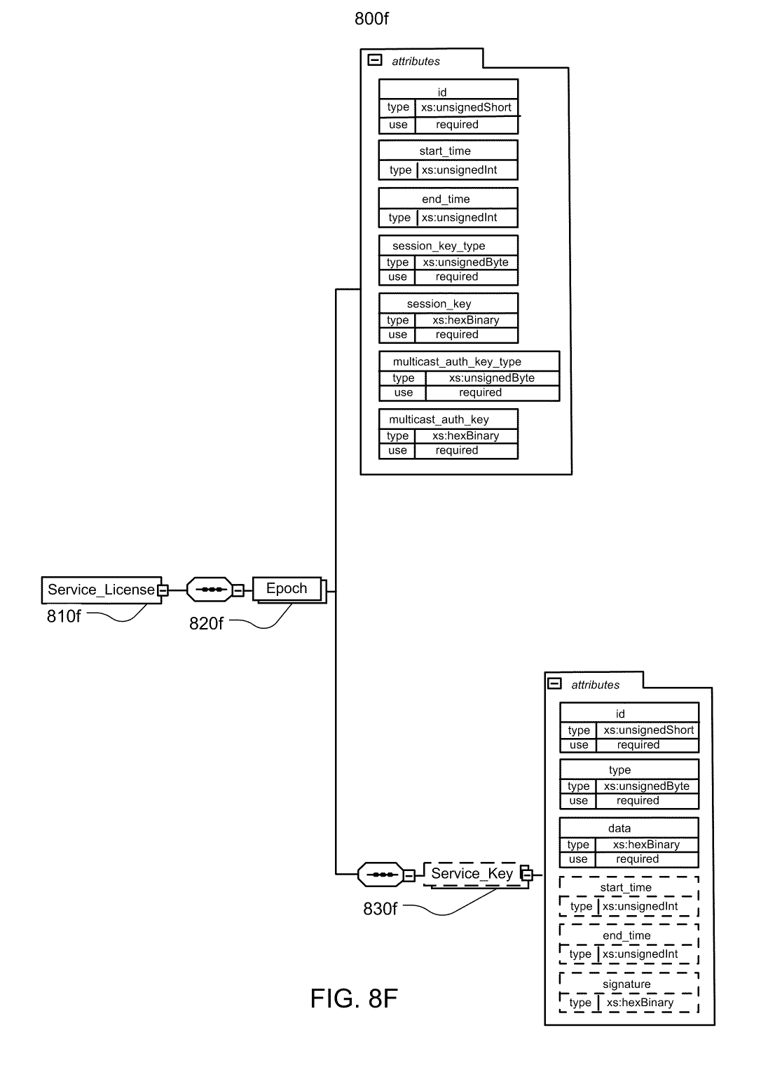

FIGS. 8A-8F show exemplary protocol definitions for providing time-based merchandising and access control. In some implementations, the protocol definitions may include additional or different elements. The elements of FIGS. 8A-8F and other elements (not shown) can include additional or different attributes.

FIG. 8A shows an exemplary merchandising structure 800a. The merchandising structure is carried within a marketplace content retailer message. One or more market content retailer messages may be included in marketplace system information, which provides subscription package information to a user device. As shown in FIG. 8A, the merchandising structure 800a can be defined in XML format. The merchandising structure 800a includes the packageInfo element 810a. In certain implementations, the packageInfo element 810a describes information related to a content provider's service package. For example, packageInfo element 810a may describe the service package information for a sports package provided by ESPN™. In certain implementations, the packageInfo element 810a includes a packageType attribute and zero or more priceMethod elements 820a.

The packageType attribute indicates a type for a service package. The table shows exemplary service package types and corresponding enumeration values.

| Package Type | Enumeration value used |
|---|---|
| Root | 0 |
| Add-on | 1 |
| Auto-subscribe | 2 |
| Fixed time Root | 3 |
| Pick-A-Pack Root | 4 |

The priceMethod 820a describes zero or more subscription packages or subscription options for a service package. For example, a first instance of the priceMethod element 820a may describe an hourly floating subscription for a sports television package. A second instance of the priceMethod element 820a may describe a recurring monthly subscription supported by the same sports television package. In some implementations, a packageInfo element 810a may only have one priceMethod element 820a describing a fixed subscription for a service package. In certain implementations, a packageInfo element 810a including an instance of the priceMethod element 820a that describes a fixed time subscription may not include other instances of the priceMethod element 820a that describe floating or recurring subscriptions.

In some implementations, the priceMethod 820a includes attributes for a subscriptionMethod, a currency, and an amount. The subscriptionMethod attribute provides information indicating the subscription type of the priceMethod 820a. In particular, the subscriptionMethod attribute can describe that the priceMethod 820a is a recurring, floating time, fixed time, etc. subscription. In certain implementations, the subscriptionMethod field may be defined as the termReferenceType of the MPEG-7 multimedia content description standard. In some implementations, available time-based subscription options may be encoded as different termReferenceType types of the MPEG-7 multimedia content description standard. The table below shows exemplary subscription method types and corresponding descriptions.

| Subscription Method | Description |
|---|---|
| 1.1.1 | Monthly recurring |
| 1.2.1 | Floating time - Hour |
| 1.2.2 | Floating time - Day |
| 1.2.3 | Floating time - Week |
| 1.2.4 | Floating time - Month |
| 1.2.5 | Floating time - Year |
| 1.3 | Fixed time |

The amount attribute provides information indicating the subscription price for the priceMethod element 820a. In some implementation, the amount attribute is defined as a floating type variable. The currency attribute provides information indicating the currency for the subscription of the priceMethod element 820a. In some implementations, the currency attribute may be defined as a three letter string type. The three letter string may conform to ISO 4237 for providing currency information.

As shown in FIG. 8A, the priceMethod 820a can contain a closed element 822a, an unSubscriptionFrmDvcAllowed element 824a, a timeMultiple element 826a, and a timePeriod element 828a.

The closed element 822a indicates whether priceMethod element 820a is available for subscription. For example, the closed element 822a may indicate that new purchases of an hourly floating subscriptions defined by the priceMethod element 820a are not to be permitted. In certain implementations, setting the closed element 822a to the closed state would cause a user device to not indicate or accept requests for an associated subscription defined by the priceMethod element 820a. For example, if the closed element 822a is set to the closed state, an associated subscription defined by the priceMethod element 820a would not appear in a subscriptions menu GUI provided by a user device to a user. In certain implementations, closing a subscription method does not affect service access for current subscribers. In these implementations, the current subscribers are permitted to access services provided by the package until their subscription ends. In some implementations, the closed element 822a is defined by a Boolean type variable. In certain implementations, if the closed element is present, the priceMethod element 820a is considered closed.

The unSubscriptionFrmDvcAllowed element 824a indicates whether an active package subscribed using the corresponding priceMethod element 820 can be unsubscribed from a user device. For example, the unSubscriptionFrmDvcAllowed element 824a may indicate that a weekly floating subscription may be unsubscribed from a user device. As another example, the unSubscriptionFrmDvcAllowed element 824a may indicate that an hourly floating subscription may not be unsubscribed from a user device. In some implementations, the unSubscriptionFrmDvcAllowed element 824a is defined by a Boolean type variable. In certain implementations, if the unSubscriptionFrmDvcAllowed element 824a is present, unsubscribing from an associated subscription package is permitted.

The timeMultiple element 826a indicates the multiplier for the time unit of a floating time subscription defined in the subscriptionMethod attribute of priceMethod element 820a. For example, the subscriptionMethod attribute may indicate a daily floating subscription package. If the timeMultiple element is set to a value of two, the particular subscription package described by the priceMethod element 820a would have an access period of two days. In some implementations, the timeMultiple element 826a is defined by an unsignedShort type variable.

In certain implementations, the timePeriod element 828a includes start time and end time elements. The start time and end time elements define the period over which access to services associated with the subscription package described by the priceMethod element 820a is permitted. In some implementations, the start time and end time elements are defined only for fixed time subscription packages. The start time indicates the start time for services associated with a package, and is represented as UNIX time. In some implementations, the start time element is defined by an unsignedInt type variable. The end time indicates the end time for services associated with a package, and is also represented as UNIX time. In some implementations, the end time element is defined by an unsignedInt type variable.

FIG. 8B shows an exemplary subscription profile structure 800b for a unicast device-to-server interface protocol. The subscription profile structure 800b may be carried within an activation response message, which describes subscription packages subscribed and/or unsubscribed by a customer service representative on behalf of a user. As shown in FIG. 8B, the subscription profile structure 800b can be defined in XML format. The subscription profile structure 800b includes the subscription_profile element 810b. In certain implementations, the subscription_profile element 810b provides a list indicating currently subscribed and unsubscribed packages for a given user device. For example, the subscription_profile element 810b may include a list indicating that a user is subscribed to a sports television package and unsubscribed to a local television package. In certain implementations, the subscription_profile element 810b includes a subscribed element 820b and an unsubscribed element 830b.

The subscribed element 820b may include one or more package elements 822b. The one or more package elements 822b provide subscription information for subscription packages to which a user device is currently subscribed. In certain implementations, the package element 822b includes attributes for id, version, subscription_method, time_multiple, start_time, and end_time.

The id attribute provides the identification value for a package. In some implementations, the id attribute field is defined as an unsignedShort type variable.

The version attribute provides version information for a package. In certain implementations, the version attribute field is defined as an unsignedShort type variable.

The subscription_method attribute provides information indicating the subscription type for an associated package element. In particular, the subscription_method attribute can describe that a subscription package is a recurring, floating time, fixed time, etc. subscription. In certain implementations, the subscription_method field is defined as a string type variable. The table below shows exemplary subscription method types and corresponding descriptions.

| Subscription Method | Description |
|---|---|
| 1.1.1 | Monthly recurring |
| 1.2.1 | Floating time - Hour |
| 1.2.2 | Floating time - Day |
| 1.2.3 | Floating time - Week |
| 1.2.4 | Floating time - Month |
| 1.2.5 | Floating time - Year |
| 1.3 | Fixed time |

The time_multiple attribute indicates the multiplier for the time unit of a floating time subscription defined in the subscription_method attribute. For example, the subscription_method attribute may indicate a floating day subscription. If the time_multiple element is set to a value of two, the particular subscription would have an access period of two days. In some implementations, the time_multiple field is defined by an unsignedInt type variable.

The start_time attribute indicates the start time for services associated with a subscription package, and is represented as UNIX time. In some implementations, the start_time field is defined by an unsignedInt type variable.

The end_time attribute indicates the end time for services associated with a package, and is also represented as UNIX time. In some implementations, the end_time field is defined by an unsignedInt type variable.

The unsubscribed element 830b may include one or more package elements 832b. The one or more package elements 832b provide subscription information for packages from which a user device is currently unsubscribed. In certain implementations, the package element 832b includes attributes for id, version, subscription_method, time_multiple, start_time, and end_time.

The id attribute provides the identification value for a package. In some implementations, the id attribute field is defined as an unsignedShort type variable.

The version attribute provides version information for a package. In certain implementations, the version attribute field is defined as an unsignedShort type variable.

The subscription_method attribute provides information indicating the subscription type for an associated package element. In particular, the subscription_method attribute can describe that a subscription package is a recurring, floating time, fixed time, etc. subscription. In certain implementations, the subscription_method field is defined as a string type variable. The table below shows exemplary subscription method types and corresponding descriptions.

| Subscription Method | Description |
|---|---|
| 1.1.1 | Monthly recurring |
| 1.2.1 | Floating time - Hour |
| 1.2.2 | Floating time - Day |
| 1.2.3 | Floating time - Week |
| 1.2.4 | Floating time - Month |
| 1.2.5 | Floating time - Year |
| 1.3 | Fixed time |

The time_multiple attribute indicates the multiplier for the time unit of a floating time subscription defined in the subscription_method attribute. For example, the subscription_method attribute may indicate a floating day subscription. If the time_multiple element is set to a value of two, the particular subscription would have an access period of two days. In some implementations, the time_multiple field is defined by an unsignedInt type variable.

The start_time attribute indicates the start time for services associated with a subscription package, and is represented as UNIX time. In some implementations, the start_time field is defined by an unsignedInt type variable.

The end_time attribute indicates the end time for services associated with a package, and is also represented as UNIX time. In some implementations, the end_time field is defined by an unsignedInt type variable.

FIG. 8C shows an exemplary get subscription information response structure 800c for a unicast device-to-server interface protocol. The get subscription information response structure 800c may be carried within a get subscription information response message, which describes subscription packages subscribed to and unsubscribed from a user device. As shown in FIG. 8C, the get subscription information response structure 800c can be defined in XML format. The get subscription information response structure 800c includes the get_subscription_profile_rsp element 810c. In certain implementations, the get_subscription_profile_rsp element 810c includes subscription_profile element 820c. In certain implementations, the subscription_profile element 820c provides a list indicating currently subscribed and unsubscribed packages associated with a given user device. For example, the subscription_profile element 820c may include a list indicating that a user is subscribed to a sports package and unsubscribed to a local package. In certain implementations, the subscription_profile element 820c includes a subscribed element 830c and an unsubscribed element 840c.

The subscribed element 830c may include one or more package elements 832c. The one or more package elements 832c provide subscription information for subscription packages to which a user device is currently subscribed. In certain implementations, the package element 832c includes attributes for id, version, subscription_method, time_multiple, start_time, and end_time.

The id attribute provides the identification value for a package. In some implementations, the id attribute field is defined as an unsignedShort type variable.

The version attribute provides version information for a package. In certain implementations, the version attribute field is defined as an unsignedShort type variable.

The subscription_method attribute provides information indicating the subscription type for an associated package element. In particular, the subscription_method attribute can describe that a subscription package is a recurring, floating time, fixed time, etc. subscription. In certain implementations, the subscription_method field is defined as a string type variable. The table below shows exemplary subscription method types and corresponding descriptions.

| Subscription Method | Description |
|---|---|
| 1.1.1 | Monthly recurring |
| 1.2.1 | Floating time - Hour |
| 1.2.2 | Floating time - Day |
| 1.2.3 | Floating time - Week |
| 1.2.4 | Floating time - Month |
| 1.2.5 | Floating time - Year |
| 1.3 | Fixed time |

The time_multiple attribute indicates the multiplier for the time unit of a floating time subscription defined in the subscription_method attribute. For example, the subscription_method attribute may indicate a floating day subscription. If the time_multiple element is set to a value of two, the particular subscription would have an access period of two days. In some implementations, the time_multiple field is defined by an unsignedInt type variable.

The start_time attribute indicates the start time for services associated with a subscription package, and is represented as UNIX time. In some implementations, the start_time field is defined by an unsignedInt type variable.

The end_time attribute indicates the end time for services associated with a package, and is also represented as UNIX time. In some implementations, the end_time field is defined by an unsignedInt type variable.

The unsubscribed element 840c may include one or more package elements 842c. The one or more package elements 842c provide subscription information for packages from which a user device is currently unsubscribed. In certain implementations, the package element 842c includes attributes for id, version, subscription_method, time_multiple, start_time, and end_time.

The id attribute provides the identification value for a package. In some implementations, the id attribute field is defined as an unsignedShort type variable.

The version attribute provides version information for a package. In certain implementations, the version attribute field is defined as an unsignedShort type variable.

The subscription_method attribute provides information indicating the subscription type for an associated package element. In particular, the subscription_method attribute can describe that a subscription package is a recurring, floating time, fixed time, etc. subscription. In certain implementations, the subscription_method field is defined as a string type variable. The table below shows exemplary subscription method types and corresponding descriptions.

| Subscription Method | Description |
|---|---|
| 1.1.1 | Monthly recurring |
| 1.2.1 | Floating time - Hour |
| 1.2.2 | Floating time - Day |
| 1.2.3 | Floating time - Week |
| 1.2.4 | Floating time - Month |
| 1.2.5 | Floating time - Year |
| 1.3 | Fixed time |

The time_multiple attribute indicates the multiplier for the time unit of a floating time subscription defined in the subscription_method attribute. For example, the subscription_method attribute may indicate a floating day subscription. If the time_multiple element is set to a value of two, the particular subscription would have an access period of two days. In some implementations, the time_multiple field is defined by an unsignedInt type variable.

The start_time attribute indicates the start time for services associated with a subscription package, and is represented as UNIX time. In some implementations, the start_time field is defined by an unsignedInt type variable.

The end_time attribute indicates the end time for services associated with a package, and is also represented as UNIX time. In some implementations, the end_time field is defined by an unsignedInt type variable.

FIG. 8D shows an exemplary update subscription profile request structure 800d for a unicast device-to-server interface protocol. The update subscription profile request structure 800d may be carried within an update subscription request message, which describes subscription packages to which a user device is subscribed and from which a user device is unsubscribed. As shown in FIG. 8D, the update subscription profile request structure 800d can be defined in XML format. The update subscription profile request structure 800d includes the update_subscription_req element 810d. In certain implementations, the update_subscription_req element 810d includes a list indicating currently subscribed and unsubscribed packages associated with a given user device. For example, the update_subscription_req element 810d may include a list indicating that a user is subscribed to a sports package and unsubscribed to a local package. In certain implementations, the update_subscription_req element 810d includes a subscribed element 820d and an unsubscribed element 830d.

The subscribed element 820d may include one or more package elements 822d. The one or more package elements 822d provide subscription information for subscription packages to which a user device is currently subscribed. In certain implementations, the package element 822d includes attributes for id, version, subscription_method, time_multiple, start_time, and end_time.

The id attribute provides the identification value for a package. In some implementations, the id attribute field is defined as an unsignedShort type variable.

The version attribute provides version information for a package. In certain implementations, the version attribute field is defined as an unsignedShort type variable.

The subscription_method attribute provides information indicating the subscription type for an associated package element. In particular, the subscription_method attribute can describe that a subscription package is a recurring, floating time, fixed time, etc. subscription. In certain implementations, the subscription_method field is defined as a string type variable. The table below shows exemplary subscription method types and corresponding descriptions.

| Subscription Method | Description |
|---|---|
| 1.1.1 | Monthly recurring |
| 1.2.1 | Floating time - Hour |
| 1.2.2 | Floating time - Day |
| 1.2.3 | Floating time - Week |
| 1.2.4 | Floating time - Month |
| 1.2.5 | Floating time - Year |
| 1.3 | Fixed time |

The time_multiple attribute indicates the multiplier for the time unit of a floating time subscription defined in the subscription_method attribute. For example, the subscription_method attribute may indicate a floating day subscription. If the time_multiple element is set to a value of two, the particular subscription would have an access period of two days. In some implementations, the time_multiple field is defined by an unsignedInt type variable.

The start_time attribute indicates the start time for services associated with a subscription package, and is represented as UNIX time. In some implementations, the start_time field is defined by an unsignedInt type variable.

The end_time attribute indicates the end time for services associated with a package, and is also represented as UNIX time. In some implementations, the end_time field is defined by an unsignedInt type variable.

The unsubscribed element 830d may include one or more package elements 832d. The one or more package elements 832d provide subscription information for packages from which a user device is currently unsubscribed. In certain implementations, the package element 832d includes attributes for id, version, subscription_method, time_multiple, start_time, and end_time.

The id attribute provides the identification value for a package. In some implementations, the id attribute field is defined as an unsignedShort type variable.

The version attribute provides version information for a package. In certain implementations, the version attribute field is defined as an unsignedShort type variable.

The subscription_method attribute provides information indicating the subscription type for an associated package element. In particular, the subscription_method attribute can describe that a subscription package is a recurring, floating time, fixed time, etc. subscription. In certain implementations, the subscription_method field is defined as a string type variable. The table below shows exemplary subscription method types and corresponding descriptions.

| Subscription Method | Description |
|---|---|
| 1.1.1 | Monthly recurring |
| 1.2.1 | Floating time - Hour |
| 1.2.2 | Floating time - Day |
| 1.2.3 | Floating time - Week |
| 1.2.4 | Floating time - Month |
| 1.2.5 | Floating time - Year |
| 1.3 | Fixed time |

The time_multiple attribute indicates the multiplier for the time unit of a floating time subscription defined in the subscription_method attribute. For example, the subscription_method attribute may indicate a floating day subscription. If the time_multiple element is set to a value of two, the particular subscription would have an access period of two days. In some implementations, the time_multiple field is defined by an unsignedInt type variable.

The start_time attribute indicates the start time for services associated with a subscription package, and is represented as UNIX time. In some implementations, the start_time field is defined by an unsignedInt type variable.

The end_time attribute indicates the end time for services associated with a package, and is also represented as UNIX time. In some implementations, the end_time field is defined by an unsignedInt type variable.

FIG. 8E shows an exemplary update subscription profile response structure 800e for a unicast device-to-server interface protocol. The update subscription profile response structure 800e may be carried within an update subscription response message, which describes subscription packages subscribed to and unsubscribed from a user device. As shown in FIG. 8E, the update subscription profile response structure 800e can be defined in XML format. The update subscription profile response structure 800e includes the update_subscription_rsp element 810e. In certain implementations, the update_subscription_rsp element 810e includes subscription_profile element 820e and zero or more package_response elements 850e. In certain implementations, the package_response element 850e includes attributes for package_id, result_code, and result_description. The package_id attribute provides a package identifier value for a package. In some implementations, the package_id attribute field is defined as an unsignedShort type variable. The result_code attribute provides a result code associated for the particular package. In some implementations, the result_code attribute field is defined as an unsignedByte type variable. The result_description attribute is defined as a string type variable.

In certain implementations, the subscription_profile element 820e provides a list indicating currently subscribed and unsubscribed packages associated with a given user device. For example, the subscription_profile element 820e may include a list indicating that a user is subscribed to a sports package and unsubscribed to a local package. In certain implementations, the subscription_profile element 820e includes a subscribed element 830e and an unsubscribed element 840e.

The subscribed element 830e may include one or more package elements 832e. The one or more package elements 832e provide subscription information for subscription packages to which a user device is currently subscribed. In certain implementations, the package element 832e includes attributes for id, version, subscription_method, time_multiple, start_time, and end_time.

The id attribute provides the identification value for a package. In some implementations, the id attribute field is defined as an unsignedShort type variable.

The version attribute provides version information for a package. In certain implementations, the version attribute field is defined as an unsignedShort type variable.

The subscription_method attribute provides information indicating the subscription type for an associated package element. In particular, the subscription_method attribute can describe that a subscription package is a recurring, floating time, fixed time, etc. subscription. In certain implementations, the subscription method field is defined as a string type variable. The table below shows exemplary subscription method types and corresponding descriptions.

| Subscription Method | Description |
|---|---|
| 1.1.1 | Monthly recurring |
| 1.2.1 | Floating time - Hour |
| 1.2.2 | Floating time - Day |
| 1.2.3 | Floating time - Week |
| 1.2.4 | Floating time - Month |
| 1.2.5 | Floating time - Year |
| 1.3 | Fixed time |

The time_multiple attribute indicates the multiplier for the time unit of a floating time subscription defined in the subscription_method attribute. For example, the subscription_method attribute may indicate a floating day subscription. If the time_multiple element is set to a value of two, the particular subscription would have an access period of two days. In some implementations, the time_multiple field is defined by an unsignedInt type variable.

The start_time attribute indicates the start time for services associated with a subscription package, and is represented as UNIX time. In some implementations, the start_time field is defined by an unsignedInt type variable.

The end_time attribute indicates the end time for services associated with a package, and is also represented as UNIX time. In some implementations, the end_time field is defined by an unsignedInt type variable.

The unsubscribed element 840e may include one or more package elements 842e. The one or more package elements 842e provide subscription information for packages from which a user device is currently unsubscribed. In certain implementations, the package element 842e includes attributes for id, version, subscription_method, time_multiple, start_time, and end_time.

The id attribute provides the identification value for a package. In some implementations, the id attribute field is defined as an unsignedShort type variable.

The version attribute provides version information for a package. In certain implementations, the version attribute field is defined as an unsignedShort type variable.

The subscription_method attribute provides information indicating the subscription type for an associated package element. In particular, the subscription_method attribute can describe that a subscription package is a recurring, floating time, fixed time, etc. subscription. In certain implementations, the subscription_method field is defined as a string type variable. The table below shows exemplary subscription method types and corresponding descriptions.

| Subscription Method | Description |
|---|---|
| 1.1.1 | Monthly recurring |
| 1.2.1 | Floating time - Hour |
| 1.2.2 | Floating time - Day |
| 1.2.3 | Floating time - Week |
| 1.2.4 | Floating time - Month |
| 1.2.5 | Floating time - Year |
| 1.3 | Fixed time |

The time_multiple attribute indicates the multiplier for the time unit of a floating time subscription defined in the subscription_method attribute. For example, the subscription_method attribute may indicate a floating day subscription. If the time_multiple element is set to a value of two, the particular subscription would have an access period of two days. In some implementations, the time_multiple field is defined by an unsignedInt type variable.

The start_time attribute indicates the start time for services associated with a subscription package, and is represented as UNIX time. In some implementations, the start_time field is defined by an unsignedInt type variable.

The end_time attribute indicates the end time for services associated with a package, and is also represented as UNIX time. In some implementations, the end_time field is defined by an unsignedInt type variable.

FIG. 8F shows an exemplary service license structure 800f for a unicast device-to-server interface protocol. The service license structure 800f may be carried within a service device license delivery response message, which provides service license information to a user device. As shown in FIG. 8F, the service license structure 800f can be defined in XML format. The service license structure 800f includes the service license element 810f. In certain implementations, the service license element 810f includes one or more epoch elements 820f.

The epoch element 820f provides information related to service license key epochs. In certain implementations, the epoch element 820f includes attributes for id, start_time, end_time, session_key_type, session_key, multicast_auth_key_type, and multicast_auth_key. In some implementations, the epoch element 820f may include zero or more service key elements 830f.

The id attribute indicates an epoch identifier for the epoch element 820f. In some implementations, the id field is an unsignedInt type variable. The start_time attribute indicates a start time for the epoch element 820f. In some implementations, the start_time field is an unsignedInt type variable. The end_time attribute indicates an end time for the epoch element 820e. In some implementations, the end_time field is an unsignedInt type variable. The session_key_type attribute indicates a session key type for the epoch element 820f. In some implementations, the session_key_type field is an unsignedByte type variable. The session_key attribute provides session key data for the epoch element 820f. In some implementations, the session_key field is a hexBinary type variable. The multicast_auth_key_type attribute indicates a multicast authentication key type for the epoch element 820f. In some implementations, the multicast_auth_key_type field is an unsignedByte type variable. The multicast_auth_key attribute provides multicast authentication key data for the epoch element 820f. In some implementations, the multicast_auth_key field is a hexBinary type variable.

In some implementations, the service_key element 830f includes attributes for id, type, data, start_time, end_time, and signature. The id attribute indicates a service identifier for the service_key element 830f. In some implementations, the id field is an unsignedShort type variable. The type attribute indicates a session key type for the service_key element 830f. In some implementations, the type field is an unsignedByte type variable.

The start_time attribute indicates a start time for the service_key element 830f. In some implementations, the start_time field is an unsignedInt type variable. The end_time attribute indicates an end time for the service_key element 830f. In some implementations, the end_time field is an unsignedInt type variable. The signature attribute indicates a signature value for the service_key element 830f. In some implementations, the signature field is a hexBinary type variable.

### Second Merchandising and Access Control Architecture

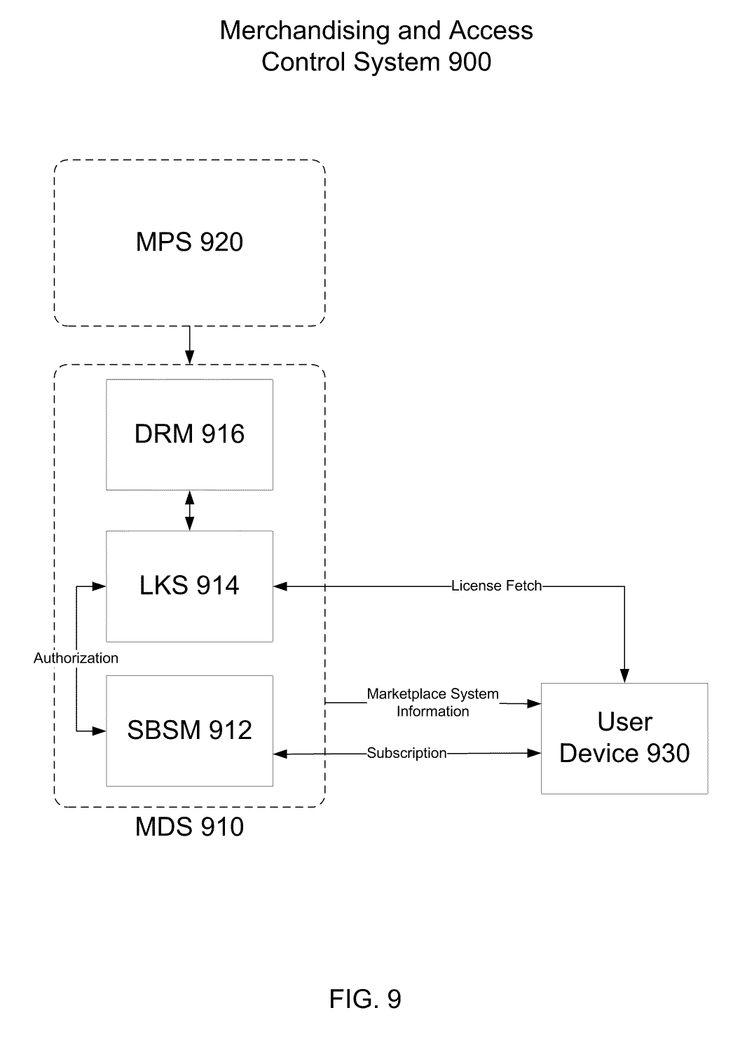

FIG. 9 illustrates a second exemplary architecture for a merchandising and access control system 900 configured to provide support for floating and fixed time merchandising. In some implementations, the functions provided by the components of the merchandising and access control system 900 are implemented in fewer components or more components (not shown) than the components illustrated in FIG. 9. For example, the merchandising and access control system 900 may use any suitable component or components of the MediaFLO™ system logical architecture 200 shown in FIG. 2.

The merchandising and access control system 900 can include an MDS 910, an MPS 920, and one or more user devices 930.

The MDS 910 is similar to the MDS 230 shown in FIG. 2. The MDS 910 may provide, for example, efficient distribution of encrypted content across one or more wireless networks to the user device 930. Wireless networks can include data optimized (DO) networks, DO-multicast networks, 3G or 4G networks, and FLO networks. In some implementations, the MDS 910 may distribute content and marketplace system information to the user device 930. Marketplace system information may include information regarding service packages and service subscription packages. In certain implementations, service subscription packages may include floating and/or fixed time subscriptions.

In certain implementations, the MDS 910 can include one or more of the following subsystems: subscription, billing and service management (SBSM) 912, license key server (LKS) 914, and digital rights management (DRM) 916.

The SBSM subsystem 912 can manage and provide service subscription packages. In some implementations, the SBSM subsystem 912 can include a subscription request handler component (SRH) (not shown). The SRH may handle subscription requests received from the user device 930. The SRH can further store subscription related information for the user device 930 in persistent subscription storage. The SRH can additionally send a response to the user device 930 indicating the success or failure of a subscription request. Subscription requests may include subscription information for service packages to which a user operating the user device 930 wants to subscribe. Subscription requests may further include or alternatively include service packages from which a user operating the user device 930 wants to unsubscribe. In some implementations, subscription requests may include information regarding floating and/or fixed time subscriptions.

The LKS 914 can receive and manage license requests from the user device 930. The LKS 914 may additionally distribute encrypted service keys and service key lifetime information to the user device 930.

The DRM subsystem 916 can generate encrypted service keys for one or more services. The service keys may be used to decrypt and gain access to service content.

The MPS 920 is similar to the MPS 210 shown in FIG. 2. The MPS 920 can provide one or more web services programming interfaces. Web and software developers can generate custom web service applications through the web service programming interface. For instance, a developer using the MPS 920 can generate and offer subscription packages to users. In addition, the MPS 920 can automatically modify service packages and transmit updated service package information to the MDS 910 for inclusion in marketplace system information. For example, the MPS 920 may automatically create, close, and delete service packages. Creating a service package causes a subscription package to the service package to become available for purchase by a user device. After purchasing the subscription, a user device can begin accessing the content provided by the service package. Closing a service package causes the service package to become unavailable for subscription. However, user devices that previously purchased a subscription package to the service package may continue to access content provided by the service package. Deleting a service package causes access to the content provided by the service package to cease for subscribed user devices.

The user device 930 can include or be any suitable device for communicating with the MDS 910. The user device 930 may be any suitable device including a cellular phone, a smartphone, a personal digital assistant (PDA), a pager, a laptop computer, a desktop computer, a tablet device, a computing device integrated into a vehicle, and the like. The user device 930 may include a computer-readable medium (CRM) and a processor that is coupled to the CRM (both not shown). The user device 930 may further include a conditional access system (CAS) component (not shown) for enforcing access to service content. The CAS component may be embodied on the CRM.

### Second Implementation: Process for Floating Time Merchandising and Access Control

According to certain implementations, the time merchandising and access control system 900 may provide floating time subscriptions by repeatedly and automatically creating, closing, and deleting multiple instances of a service package. In some implementations, each floating time service package may be defined by a subscription period and a time pass period. A subscription period defines a period of time for which a user may subscribe to a subscription for a particular instance of a service package. A time pass period defines a period of time in which a user may continue to access the services provided by a particular instance of a service package following the end of the subscription period for that particular instance of the service package. In some implementations, the subscription period may be a multiple of the time pass period. For example, the subscription period may be 12 hours, and the time pass period may be 24 hours. In some implementations, an instance of a service package may be deleted after the end of a period defined by its subscription period plus time pass period.

In some implementations, creating a service package and indicating that the service package is a floating time package causes the automatic creation, closing, and deleting of instances of the service package. In certain implementations, the initial instance of the service package is assumed to have been created at the last 12 a.m. For example, if a service package is created at 8 a.m. and the subscription period is 12 hours, the initial instance of the service package (also created at 8 a.m.) is assumed to have been created at 12 a.m. The automatic creation, closing, and deleting of instances of the service package stops when the service package itself is deleted.

In some implementations, creating, closing, and deleting multiple instances of a service package may occur in a staggered manner. For example, a first instance of a service package may be created at a first time. A second instance of the service package may be created at a second time. A third instance of the service package may further be created at a third time.

In some implementations, each instance of a service package is associated with the same tier (e.g., same set of services). For example, a service package may be associated with both a sports news channel and a baseball news channel. Accordingly, all instances of the service package would be associated with both channels. In certain implementations, each instance of the service package is assigned a new package identifier when created.

In some implementations, an instance of a service package may be created at the same or at substantially the same time as the time that a preceding instance of the service package is closed. In some implementations, only one instance of a service package may be open (i.e., not closed) at any given point in time. For example, three instances of a service package may be active (i.e., not deleted) at a particular point in time. However, only one instance may be open at that particular point in time and available for user devices to purchase a subscription. That is, the particular point in time only falls within the subscription period of that one instance.

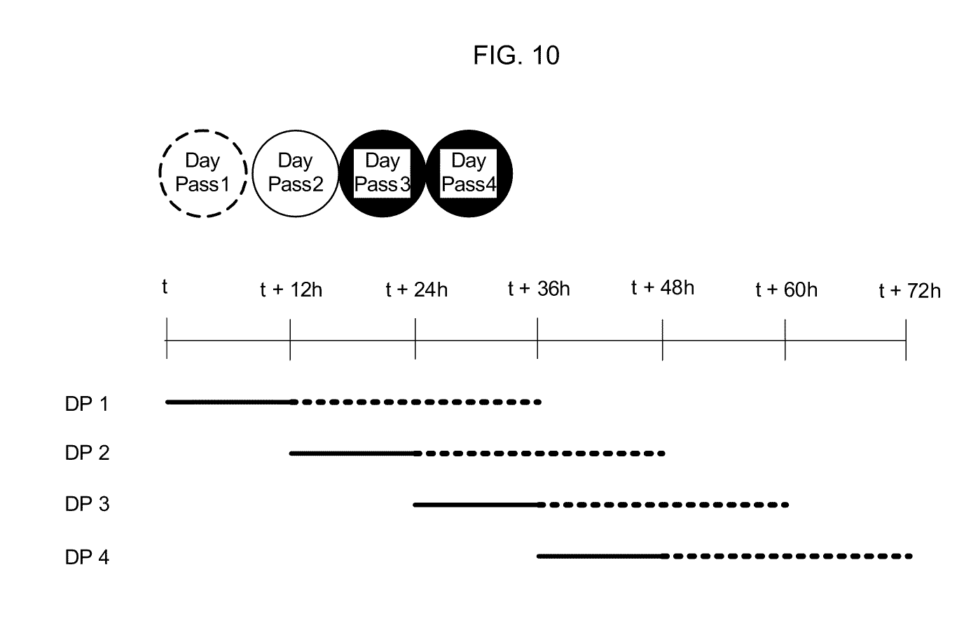

FIG. 10 shows a timing diagramming demonstrating the manner in which multiple instances of a service package are created, closed, and deleted in order to provide floating time subscription packages.

In particular, FIG. 10 shows four successive instances of the Day Pass service package. Each instance of the Day Pass service package is defined by a subscription period of 12 hours and a time pass period of 24 hours. Day Pass1 is created at time t, and includes a subscription period of 12 hours. Therefore, from t until t+12 h, a user device may purchase a subscription for Day Pass1. At t+12 h, Day Pass1 is “closed.” Thus, a user device may not purchase a subscription for Day Pass1 after t+12 h. However, those user devices that purchased a subscription to Day Pass1 between t and t+12 h can continue to access the services provided by Day Pass1 until Day Pass1 is deleted at the end of its time pass period (i.e., at t+36 h). Upon the closing of Day Pass1, Day Pass2 is created at t+12 h. Day Pass2 also includes a subscription period of 12 hours. Thus, from t+12 h until t+24 h, a user device may purchase a subscription for Day Pass2. At t+24 h, Day Pass2 is closed, and Day Pass3 is created. At t+36 h, Day Pass3 is closed, and Day Pass4 is created. In addition, t+36 h coincides with the end of the time period for Day Pass1. As such, Day Pass1 is deleted at t+36 h and access to the content provided by the Day Pass1 for user devices with a subscription to the service package instance ceases.

Subscription periods and time pass periods may be any suitable time period. In certain implementations, each instance of a service package may include subscription periods of the same duration. For example, two instances of a service package may each have 12 hour subscription periods. The first instance may include a subscription period lasting from t to t+12 h. The second instance may have its subscription period lasting from t+12 h to t+24 h. In some implementations, each instance of a service package may include time pass periods of the same duration. For example, two instances of a service package may each have 24 hour time pass periods. The first instance may include a time pass period lasting from t+12 h to t+36 h. The second instance may include a time pass period lasting from t+24 h to t+48 h.

Furthermore, any suitable number of service packages may be active at any given time. For example, as previously shown in FIG. 10, three instances of a service package may be active at any given point in time. As another example, a subscription period for each instance of a service package may be 6 hours. The time pass period for each instance of the service package may be 24 hours. Accordingly, there may be five instances of the service package active at any given point in time.

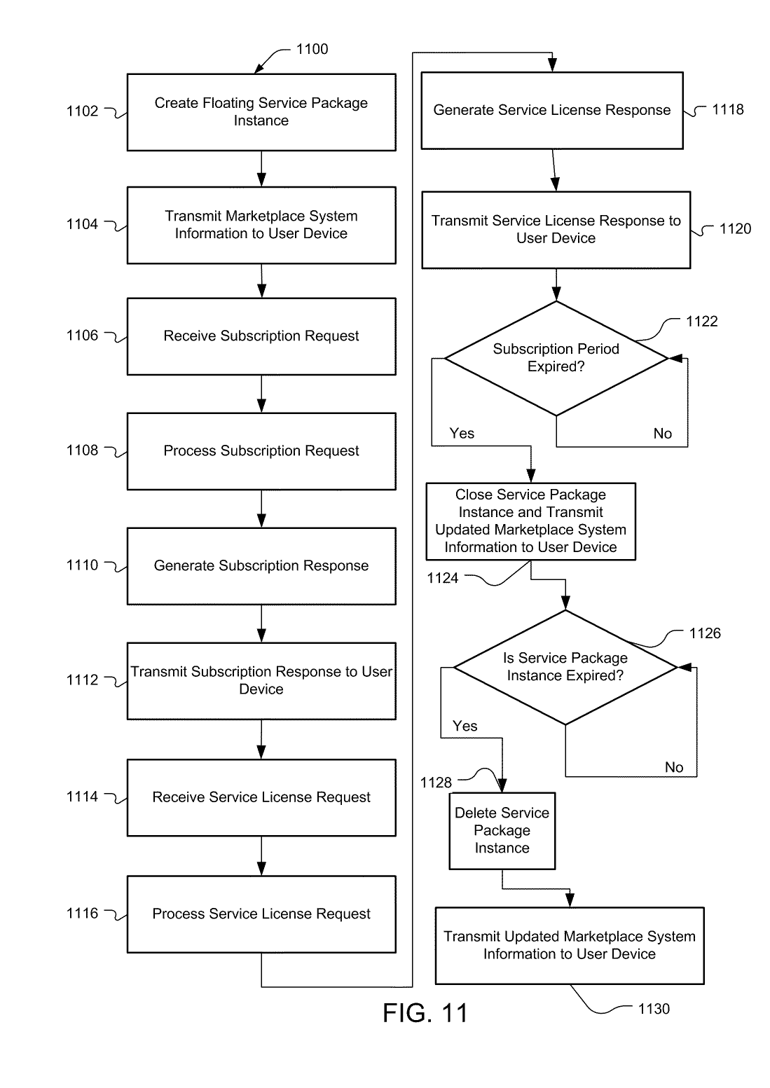

Referring to FIG. 11, a process 1100, according to a second implementation, for providing floating time merchandising and access control using system 900 includes the stages shown. The process 1100 is exemplary only and not limiting. The process 1100 can be altered in any suitable manner (e.g., by having stages added, removed, or rearranged).

In certain implementations, communication between the MDS 910 and the user device 930 may be performed according to a device-to-server interface protocol, such as a unicast device-to-server interface protocol. For example, in some implementations, messages exchanged between the MDS 910 and the user device 930 may be generated according to a device-to-server interface protocol. As another example, request and response messages exchanged between the MDS 910 and the user device 930 may additionally be transmitted according to a device-to-server interface protocol.

At stage 1102, the MPS 920 creates one or more floating time service package instances for inclusion in the marketplace system information. By creating the floating time service package instances, the MPS 920 permits a user device to subscribe to one or more service packages via floating time subscriptions. In some implementations, the MPS 920 may create a floating time service package instance by creating a package record for the service package instance for inclusion in the marketplace system information. In some implementations, the package record may include subscription package or subscription option information (e.g., timing and purchase price information). For example, a package record may indicate the start and end times for a floating time service package instance.

At stage 1104, the MDS 910 transmits the marketplace system information to the user device 930.

Stages 1106-1120 are similar to stages 404-418, respectively, as shown in FIG. 4 except that the various requests and responses exchanged among the system components may not include timing information regarding floating and fixed time subscriptions. In some implementations, the various requests and responses may include timing information, but the system components may not use the provided timing information during processing.

At decision 1122, the MPS 920 automatically determines if the subscription periods for one or more floating time service package instances have expired. In particular, the MPS 920 may determine whether the current time falls outside a time period beginning at the creation of the service package instance and ending after a duration defined by the subscription period for the service package instance. For those floating service package instances that have expired subscription periods (the “yes” branch of decision 1122), the MPS 920 closes the packages. The MPS 920 may close the service package instances by setting a closed element in a package record associated with each service package instance in the marketplace system information at stage 1124. The MDS 910 may also send updated marketplace system information to the user devices indicating that the service package instances are closed. For those floating service package instances that have not expired (the “no” branch of decision 1122), the MPS 920 does not close the service package instance, and may wait until a later time to determine whether their subscription periods have expired.

At decision 1126, the MPS 920 determines whether one or more floating time service package instances have expired. The MPS 920 may determine whether a floating time service package instance has expired by checking whether the current time falls outside a time period beginning at the creation of the service package instance and ending after a duration defined by the subscription period plus the time pass period for the service package instance. For example, a floating time service package instance may have been created at t. The subscription period may be 12 hours. The time pass period may further be 24 hours. As a result, the floating time service package instance would be accessible for a period beginning at t and ending at t+36 h. If the current time is beyond the period (e.g., t+37 h), the MPS 920 would determine that the floating service package instance has expired (the “yes” branch of decision 1126). If the MPS 920 determines that a floating service package instance has expired, the MPS 920 deletes the service package instance at stage 1128. In particular, the MPS 920 may delete an associated service package record from the marketplace system information. If the MPS 920 determines that a floating service time package instance has not expired (the “no” branch of decision 1126), the MPS 920 does not delete the floating time service package instance and may wait until a later time to determine whether the service package instance has expired.

At stage 1130, the MDS 910 transmits updated marketplace system information to the user device 930.

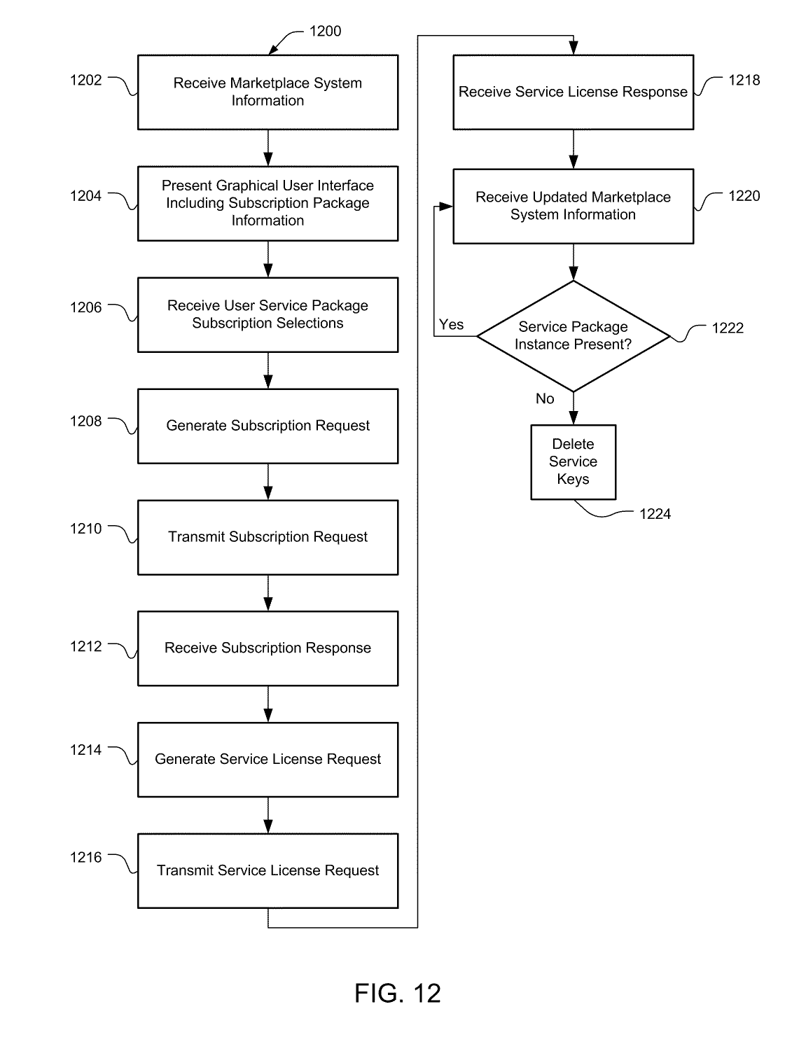

Referring to FIG. 12, a process 1200, according to a second implementation, for handling floating time merchandising on a user device in the merchandising and access control system 900 includes the stages shown. The process 1200 is exemplary only and not limiting. The process 1200 can be altered in any suitable manner (e.g., by having stages added, removed, or rearranged).

In certain implementations, communication between the MDS 910 and user device 930 may be performed according to a device-to-server interface protocol, such as a unicast device-to-server interface protocol. For example, in some implementations, messages exchanged between the MDS 910 and the user device 930 may be generated according to a device-to-server interface protocol. As another example, request and response messages exchanged between the MDS 910 and the user device 930 may additionally be transmitted according to a device-to-server interface protocol.

At stage 1202, the user device 930 receives marketplace system information from the MDS 910. The marketplace system information may include relevant data regarding one or more floating time service package instances. In particular, the marketplace system information may include package records describing the one or more floating time service package instances. In some implementations, the marketplace system information may further include subscription package or subscription option information (e.g., timing and purchase price information) for the floating time service package instances.

At stage 1204, the user device 930 generates a GUI for presenting information based on the marketplace system information. The GUI may provide, to a user, information regarding available subscription packages. For example, the user device 930 may generate a GUI including a subscriptions menu. The subscriptions menu may provide information regarding available service subscription packages, associated subscription types, associated timing information, and associated purchase prices.

Stages 1206-1218 are similar to stages 606-618, respectively, as shown in FIG. 6 except that the various requests and responses exchanged among the system components may not include timing information regarding floating and fixed time subscriptions. In some implementations, the various requests and responses may include timing information, but the system components may not use the provided timing information during processing.

At stage 1220, the user device 930 receives updated marketplace system information from the MDS 910. Upon receiving the updated marketplace system information, the user device 930 determines if information for one or more floating time service package instances are present in the updated marketplace system information at decision 1222. In particular, the user device 930 may determine if package records for one or more floating time service package instances are present in the updated marketplace system information. For the floating time service package instances that are present (the “yes” branch of decision 1222), the user device 930 does not delete the service keys for the services associated with those floating time service package instances. As a result, the user device 930 may continue to access the services provided by the service package instances. The user device 930 may again determine if the floating time service package instances are present at a later time, such as after receiving another marketplace system information update. For floating time service package instances that are absent (the “no” branch of decision 1222), the user device 930 deletes the service keys for the services associated with the absent service package instances at stage 1224. As a result, the user device 930 may not continue to access the services of the service package instances. In some implementations, the user device 930 only deletes a service key for a service if all of the user device's 930 subscribed service packages associated with the service are absent in the updated marketplace system information. For example, the user device 930 may be subscribed to a floating time service package instance and a recurring service package. Both service packages may include the same children's television channel. The user device 930 may later receive updated marketplace system information in which information for the recurring service package is present, but in which information for the floating time service package instance is absent. In such a scenario, the user device 930 would not delete a service key for the children's television channel because the recurring service package is still present in the marketplace system information. In some implementations, if the user device 930 determines a floating time service package instance is absent, the user device 930 removes information (including subscription information) for the absent service package instance from an associated subscription profile.

### Considerations Regarding the Description

It is understood that the specific order or hierarchy of steps in the processes disclosed is an example of exemplary approaches. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the implementations disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the disclosure herein may be implemented or performed with a general-purpose processor, a digital signal processor (DSP), a digital signal processing device (DSPD), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, multiple microprocessors, one or more microprocessors in conjunction with a DSP core, or any other such configuration.

The blocks of a method or algorithm described in connection with the disclosure herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary designs, the functions described may be implemented in hardware, software executed by a processor, firmware, or any combination thereof. If implemented in software executed by a processor, the functions may be stored on or transmitted over as one or more instructions or code on a computer-readable medium. Computer-readable media includes both computer storage media and communication media including any medium that facilitates transfer of a computer program from one place to another. A storage medium may be any available medium that can be accessed by a general purpose or special purpose computer. By way of example, and not limitation, computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above are also included within the scope of computer-readable media.

The previous description is provided to enable any person skilled in the art to make and/or use the apparatus, systems, and methods described. Various modifications to the disclosure will be readily apparent to those skilled in the art, and the generic principles defined herein may be applied to other variations without departing from the spirit or scope of the disclosure. Thus, the disclosure is not to be limited to the examples and designs described herein but is to be accorded the widest scope consistent with the principles and novel features disclosed herein.

One or more features of the various implementations described above, may be combined with other features of other implementations in any suitable manner without departing from the scope of this disclosure.

What is claimed is:

1. A mobile broadcast system configured to provide time-based merchandising and access control, the system comprising:
a distribution module configured to transmit system information to a user device, wherein the system information includes time-based subscription information for one or more service packages, to receive a subscription request indicating a selected service package, to determine if the user device is authorized to receive the selected service package;
and to transmit a subscription response to the user device.

2. The system of claim 1, wherein the time-based subscription information includes fixed time subscription information for one or more of the one or more service packages.

3. The system of claim 2, wherein the fixed time subscription information for the one or more of the one or more service packages includes a start time and end time for each service package.

4. The system of claim 1, wherein the time-based subscription information includes floating time subscription information for one or more of the one or more service packages.

5. The system of claim 4, wherein the floating time subscription information for the one or more of the one or more service packages includes a duration for each service package.

6. The system of claim 5, wherein the duration for each service package is the product of a multiplier and a base duration.

7. The system of claim 1, wherein the subscription request is a request to subscribe to the selected service package via a first time-based subscription.

8. The system of claim 7, wherein the first time-based subscription is a fixed time subscription.

9. The system of claim 7, wherein the first time-based subscription is a floating time subscription.

10. The system of claim 7, wherein the distribution module is further configured to determine a subscription lifetime period based on the first time-based subscription.

11. The system of claim 10, wherein determining the subscription lifetime period is also based on a second time-based subscription for the selected service package.

12. The system of claim 10, wherein the distribution module is further configured to generate one or more service keys.

13. The system of claim 12, wherein a service key is generated for one or more epochs.

14. The system of claim 13, wherein the subscription lifetime period overlaps with at least a portion of each of the one or more epochs.

15. The system of claim 12, wherein each generated service key includes service key lifetime information.

16. The system of claim 15, wherein the service key lifetime information includes a start time and end time.

17. The system of claim 16, wherein each generated service key includes a service key lifetime signature.

18. The system of claim 15, wherein the distribution module is further configured to transmit a service license message to the user device, wherein the service license message includes one or more service keys.

19. The system of claim 1, wherein the subscription request is a request to unsubscribe from the selected service package.

20. A system for handling time-based merchandising and providing access control, the system comprising:
a user device configured to receive system information including time-based subscription information for one or more service packages, provide an indication of service packages available via time-based subscriptions based on the time-based subscription information for the one or more service packages, receive a selection of a service package available via a time-based subscription; and transmit a subscription request.

21. The system of claim 20, wherein the time-based subscription information includes a closed element for one or more time-based subscriptions for the one or more service packages, the closed element for each respective time-based subscription indicating whether an associated service package is available for time-based subscription.

22. The system of claim 20, wherein the time-based subscription information includes an unsubscription element for one or more time-based subscriptions for the one or more service packages, the unsubscription element for each respective subscription indicating whether the user device can unsubscribe from an associated time-based service package.

23. The system of claim 20, wherein the subscription request is a request to unsubscribe from the selected service package.

24. The system of claim 20, wherein the subscription request is a request to subscribe to the selected service package via a time-based subscription.

25. The system of claim 24, wherein the user device is further configured to receive a subscription response, and transmit a service license request.

26. The system of claim 25, wherein the user device is further configured to receive a service license message including one or more service keys for the selected service package.

27. The system of claim 26, wherein each service key for the selected service package includes service key lifetime information and a service key lifetime signature.

28. The system of claim 27, wherein the user device is further configured to verify service key lifetime information using the service key lifetime signature.

29. The system of claim 28, wherein the user device is further configured to:
receive an access request to a service associated with the selected service package;
select a service key associated with the service; and
determine if the selected service key is valid.

30. The system of claim 29, wherein determining if the service key is valid comprises:
verifying the service key lifetime information associated with the selected service key using the service key lifetime signature associated with the selected service key; and
determining if a current time is within a time period defined by the service key lifetime information associated with the selected service key.

31. The system of claim 29, wherein the user device is further configured to provide access to the service associated with the selected service package if the selected service key associated with the service is determined to be valid.

32. A method for providing time-based merchandising and access control in a mobile broadcast system, the method comprising:
transmitting system information to a user device, wherein the system information includes time-based subscription information for one or more service packages;
receiving a subscription request indicating a selected service package;
determining if the user device is authorized to receive the selected service package; and
transmitting a subscription response to the user device.

33. The method of claim 32, wherein the time-based subscription information includes fixed time subscription information for one or more of the one or more service packages.

34. The method of claim 33, wherein the fixed time subscription information for the one or more of the one or more service packages includes a start time and end time for each service package.

35. The method of claim 32, wherein the time-based subscription information includes floating time subscription information for one or more of the one or more service packages.

36. The method of claim 35, wherein the floating time subscription information for the one or more of the one or more service packages includes a duration for each service package.

37. The method of claim 36, wherein the duration for each service package is the product of a multiplier and a base duration.

38. The method of claim 32, wherein the subscription request is a request to subscribe to the selected service package via a first time-based subscription.

39. The method of claim 38, wherein the first time-based subscription is a fixed time subscription.

40. The method of claim 38, wherein the first time-based subscription is a floating time subscription.

41. The method of claim 38, further comprising determining a subscription lifetime period based on the first time-based subscription.

42. The method of claim 41, wherein determining the subscription lifetime period is also based on a second time-based subscription for the selected service package.

43. The method of claim 41, further comprising generating one or more service keys.

44. The method of claim 43, wherein a service key is generated for one or more epochs.

45. The method of claim 44, wherein the subscription lifetime period overlaps with at least a portion of each of the one or more epochs.

46. The method of claim 43, wherein each generated service key includes service key lifetime information.

47. The method of claim 46, wherein the service key lifetime information includes a start time and end time.

48. The method of claim 47, wherein each generated service key includes a service key lifetime signature.

49. The method of claim 46, further comprising transmitting a service license message to the user device, wherein the service license message includes one or more service keys.

50. The method of claim 32, wherein the subscription request is a request to unsubscribe from the selected service package.

51. A method for handling time-based merchandising and providing access control, the method comprising:
receiving system information including time-based subscription information for one or more service packages;
providing an indication of service packages available via time-based subscriptions based on the time-based subscription information for the one or more service packages;
receiving a selection of a service package available via a time-based subscription; and
transmitting a subscription request.

52. The method of claim 51, wherein the time-based subscription information includes a closed element for one or more time-based subscriptions for the one or more service packages, the closed element for each respective time-based subscription indicating whether an associated service package is available for time-based subscription.

53. The method of claim 51, wherein the time-based subscription information includes an unsubscription element for one or more time-based subscriptions for the one or more service packages, the unsubscription element for each respective subscription indicating whether the user device can unsubscribe from an associated time-based service package.

54. The method of claim 51, wherein the subscription request is a request to unsubscribe from the selected service package.

55. The method of claim 51, wherein the subscription request is a request to subscribe to the selected service package via a time-based subscription.

56. The method of claim 55, further comprising receiving a subscription response, and transmitting a service license request.

57. The method of claim 56, further comprising receiving a service license message including one or more service keys for the selected service package.

58. The method of claim 57, wherein each service key for the selected service package includes service key lifetime information and a service key lifetime signature.

59. The method of claim 58, further comprising verifying service key lifetime information using the service key lifetime signature.

60. The method of claim 59, further comprising:
receiving an access request to a service associated with the selected service package;
selecting a service key associated with the service; and
determining if the selected service key is valid.

61. The method of claim 60, wherein determining if the service key is valid comprises:
verifying the service key lifetime information associated with the selected service key using the service key lifetime signature associated with the selected service key; and
determining if a current time is within a time period defined by the service key lifetime information associated with the selected service key.

62. The method of claim 60, further comprising providing access to the service associated with the selected service package if the selected service key associated with the service is determined to be valid.

63. A computer program product comprising:
a processor-readable medium storing processor-readable instructions configured to cause a processor to:
transmit system information to a user device, wherein the system information includes time-based subscription information for one or more service packages;
receive a subscription request indicating a selected service package;
determine if the user device is authorized to receive the selected service package; and
transmit a subscription response to the user device.

64. The computer program product of claim 63, wherein the time-based subscription information includes fixed time subscription information for one or more of the one or more service packages.

65. The computer program product of claim 64, wherein the fixed time subscription information for the one or more of the one or more service packages includes a start time and end time for each service package.

66. The computer program product of claim 63, wherein the time-based subscription information includes floating time subscription information for one or more of the one or more service packages.

67. The computer program product of claim 66, wherein the floating time subscription information for the one or more of the one or more service packages includes a duration for each service package.

68. The computer program product of claim 67, wherein the duration for each service package is the product of a multiplier and a base duration.

69. The computer program product of claim 63, wherein the subscription request is a request to subscribe to the selected service package via a first time-based subscription.

70. The computer program product of claim 69, wherein the first time-based subscription is a fixed time subscription.

71. The computer program product of claim 69, wherein the first time-based subscription is a floating time subscription.

72. The computer program product of claim 69, wherein the instructions are further configured to cause the processor to determine a subscription lifetime period based on the first time-based subscription.

73. The computer program product of claim 72, wherein determining the subscription lifetime period is also based on a second time-based subscription for the selected service package.

74. The computer program product of claim 72, wherein the instructions are further configured to cause the processor to generate one or more service keys.

75. The computer program product of claim 74, wherein a service key is generated for one or more epochs.

76. The computer program product of claim 75, wherein the subscription lifetime period overlaps with at least a portion of each of the one or more epochs.

77. The computer program product of claim 74, wherein each generated service key includes service key lifetime information.

78. The computer program product of claim 77, wherein the service key lifetime information includes a start time and end time.

79. The computer program product of claim 78, wherein each generated service key includes a service key lifetime signature.

80. The computer program product of claim 77, wherein the instructions are further configured to cause the processor to transmit a service license message to the user device, wherein the service license message includes one or more service keys.

81. The computer program product of claim 63, wherein the subscription request is a request to unsubscribe from the selected service package.

82. A computer program product comprising:
a processor-readable medium storing processor-readable instructions configured to cause a processor to:
receive system information including time-based subscription information for one or more service packages;
provide an indication of service packages available via time-based subscriptions based on the time-based subscription information for the one or more service packages;
receive a selection of a service package available via a time-based subscription; and
transmit a subscription request.

83. The computer program product of claim 82, wherein the time-based subscription information includes a closed element for one or more time-based subscriptions for the one or more service packages, the closed element for each respective time-based subscription indicating whether an associated service package is available for time-based subscription.

84. The computer program product of claim 82, wherein the time-based subscription information includes an unsubscription element for one or more time-based subscriptions for the one or more service packages, the unsubscription element for each respective subscription indicating whether the user device can unsubscribe from an associated time-based service package.

85. The computer program product of claim 82, wherein the subscription request is a request to unsubscribe from the selected service package.

86. The computer program product of claim 82, wherein the subscription request is a request to subscribe to the selected service package via a time-based subscription.

87. The computer program product of claim 86, wherein the instructions are further configured to cause the processor to receive a subscription response, and transmit a service license request.

88. The computer program product of claim 87, wherein the instructions are further configured to cause the processor to receive a service license message including one or more service keys for the selected service package.

89. The computer program product of claim 88, wherein each service key for the selected service package includes service key lifetime information and a service key lifetime signature.

90. The computer program product of claim 89, wherein the instructions are further configured to cause the processor to verify service key lifetime information using the service key lifetime signature.

91. The computer program product of claim 90, wherein the instructions are further configured to cause the processor to: receive an access request to a service associated with the selected service package, select a service key associated with the service;
and determine if the selected service key is valid.

92. The computer program product of claim 91, wherein determining if the service key is valid comprises:
verifying the service key lifetime information associated with the selected service key using the service key lifetime signature associated with the selected service key; and
determining if a current time is within a time period defined by the service key lifetime information associated with the selected service key.

93. The computer program product of claim 92, wherein the instructions are further configured to cause the processor to provide access to the service associated with the selected service package if the selected service key associated with the service is determined to be valid.

94. A mobile broadcast system configured to provide time-based merchandising and access control, the system comprising:
means for transmitting system information to a user device, wherein the system information includes time-based subscription information for one or more service packages,
means for receiving a subscription request indicating a selected service package,
means for determining if the user device is authorized to receive the selected service package; and
means for transmitting a subscription response to the user device.

95. The system of claim 94, wherein the time-based subscription information includes fixed time subscription information for one or more of the one or more service packages.

96. The system of claim 95, wherein the fixed time subscription information for the one or more of the one or more service packages includes a start time and end time for each service package.

97. The system of claim 94, wherein the time-based subscription information includes floating time subscription information for one or more of the one or more service packages.

98. The system of claim 97, wherein the floating time subscription information for the one or more of the one or more service packages includes a duration for each service package.

99. The system of claim 98, wherein the duration for each service package is the product of a multiplier and a base duration.

100. The system of claim 94, wherein the subscription request is a request to subscribe to the selected service package via a first time-based subscription.

101. The system of claim 100, wherein the first time-based subscription is a fixed time subscription.

102. The system of claim 100, wherein the first time-based subscription is a floating time subscription.

103. The system of claim 100, further comprising means for determining a subscription lifetime period based on the first time-based subscription.

104. The system of claim 103, wherein determining the subscription lifetime period is also based on a second time-based subscription for the selected service package.

105. The system of claim 103, further comprising means for generating one or more service keys.

106. The system of claim 105, wherein a service key is generated for one or more epochs.

107. The system of claim 106, wherein the subscription lifetime period overlaps with at least a portion of each of the one or more epochs.

108. The system of claim 105, wherein each generated service key includes service key lifetime information.

109. The system of claim 108, wherein the service key lifetime information includes a start time and end time.

110. The system of claim 109, wherein each generated service key includes a service key lifetime signature.

111. The system of claim 108, further comprising means for transmitting a service license message to the user device, wherein the service license message includes one or more service keys.

112. The system of claim 94, wherein the subscription request is a request to unsubscribe from the selected service package.

113. A system configured for handling time-based merchandising and providing access control comprising:
means for receiving system information including time-based subscription information for one or more service packages;
means for providing an indication of service packages available via time-based subscriptions based on the time-based subscription information for the one or more service packages;
means for receiving a selection of a service package available via a time-based subscription; and
means for transmitting a subscription request.

114. The system of claim 113, wherein the time-based subscription information includes a closed element for one or more time-based subscriptions for the one or more service packages, the closed element for each respective time-based subscription indicating whether an associated service package is available for time-based subscription.

115. The system of claim 113, wherein the time-based subscription information includes an unsubscription element for one or more time-based subscriptions for the one or more service packages, the unsubscription element for each respective subscription indicating whether the user device can unsubscribe from an associated time-based service package.

116. The system of claim 113, wherein the subscription request is a request to unsubscribe from the selected service package.

117. The system of claim 113, wherein the subscription request is a request to subscribe to the selected service package via a time-based subscription.

118. The system of claim 117, further comprising means for receiving a subscription response, and transmitting a service license request.

119. The system of claim 118, further comprising means for receiving a service license message including one or more service keys for the selected service package.

120. The system of claim 119, wherein each service key for the selected service package includes service key lifetime information and a service key lifetime signature.

121. The system of claim 120, further comprising means for verifying service key lifetime information using the service key lifetime signature.

122. The system of claim 121, further comprising:
means for receiving an access request to a service associated with the selected service package;
means for selecting a service key associated with the service; and
means for determining if the selected service key is valid.

123. The system of claim 122, wherein determining if the service key is valid comprises:
verifying the service key lifetime information associated with the selected service key using the service key lifetime signature associated with the selected service key; and
determining if a current time is within a time period defined by the service key lifetime information associated with the selected service key.

124. The system of claim 122, further comprising means for providing access to the service associated with the selected service package if the selected service key associated with the service is determined to be valid.

125. A mobile broadcast system configured to provide time-based merchandising and access control, the system comprising:
a provisioning module configured to create a package record for a first instance of a service package, to close the first instance of the service package at a first time after a first duration, to create a package record for a second instance of the service package at the first time; and
a distribution module configured to transmit system information to one or more user devices, wherein the system information includes information about the first instance of the service package indicating that the first instance of the service package is available for subscription and to transmit updated system information to the one or more user devices, wherein the updated system information includes information indicating that the first instance of the service package is closed and information about the second instance of the service package indicating that the second instance of the service package is available for subscription.

126. The system of claim 125, wherein closing the first instance of the service package indicates that the first instance of the service package is no longer available for subscription.

127. The system of claim 125, wherein the provisioning module is further configured to delete the package record for the first instance of the service package at a second time after a second duration, and
wherein the distribution module is further configured to transmit updated system information to the one or more user devices, wherein the updated system information includes information indicating that the first instance of the service package is deleted.

128. The system of claim 127, wherein the information indicates that the first instance of the service package is deleted by omitting information about the first instance of the service package in the updated system information.

129. The system of claim 127, wherein the provisioning module is further configured to close the second instance of the service package at a third time after a third duration and to create a package record for a third instance of the service package at the third time; and
wherein the distribution module is further configured to transmit updated system information to the one or more user devices, wherein the updated system information includes information indicating that the second instance of the service package is closed and information about the third instance of the service package indicating that the third instance of the service package is available for subscription.

130. The system of claim 129, wherein closing the second instance of the service package indicates that the second instance of the service package is no longer available for subscription.

131. The system of claim 129, wherein the first duration is equal in time to the third duration.

132. The system of claim 129, wherein the provisioning module is further configured delete the package record for the second instance of the service package at a fourth time after a fourth duration; and
wherein the distribution module is further configured to transmit updated system information to the one or more user devices, wherein the updated system information includes information indicating that the second instance of the service package is deleted.

133. The system of claim 132, wherein the information indicates that the second instance of the service package is deleted by omitting information about the second instance of the service package in the updated system information.

134. The system of claim 132, wherein the second duration is equal in time to the fourth duration.

135. A system for handling time-based merchandising and providing access control, the system comprising:
a user device configured to receive system information including subscription information for one or more service packages, transmit a subscription request including a service package selection, receive a service license message including one or more service keys for the selected service package, receive updated system information including subscription information for one or more service packages, determine if the updated system information includes subscription information for the selected service package, and delete the one or more service keys for the selected service package if subscription information for the selected service package is not present in the updated system information.

136. The system of claim 135, wherein deleting the service keys terminates access to services associated with the service keys.

137. A method for providing time-based merchandising and access control in a mobile broadcast system, the method comprising:
creating a package record for a first instance of a service package;
transmitting system information to one or more user devices, wherein the system information includes information about the first instance of the service package indicating that the first instance of the service package is available for subscription;
closing the first instance of the service package at a first time after a first duration;
creating a package record for a second instance of the service package at the first time; and
transmitting updated system information to the one or more user devices, wherein the updated system information includes information indicating that the first instance of the service package is closed and information about the second instance of the service package indicating that the second instance of the service package is available for subscription.

138. The method of claim 137, wherein closing the first instance of the service package indicates that the first instance of the service package is no longer available for subscription.

139. The method of claim 137, further comprising:
deleting the package record for the first instance of the service package at a second time after a second duration; and
transmitting updated system information to the one or more user devices, wherein the updated system information includes information indicating that the first instance of the service package is deleted.

140. The method of claim 139, wherein the information indicates that the first instance of the service package is deleted by omitting information about the first instance of the service package in the updated system information.

141. The method of claim 139, further comprising:
closing the second instance of the service package at a third time after a third duration;
creating a package record for a third instance of the service package at the third time; and
transmitting updated system information to the one or more user devices, wherein the updated system information includes information indicating that the second instance of the service package is closed and information about the third instance of the service package indicating that the third instance of the service package is available for subscription.

142. The method of claim 141, wherein closing the second instance of the service package indicates that the second instance of the service package is no longer available for subscription.

143. The method of claim 141, wherein the first duration is equal in time to the third duration.

144. The method of claim 141, further comprising:
deleting the package record for the second instance of the service package at a fourth time after a fourth duration; and
transmitting updated system information to the one or more user devices, wherein the updated system information includes information indicating that the second instance of the service package is deleted.

145. The method of claim 144, wherein the information indicates that the second instance of the service package is deleted by omitting information about the second instance of the service package in the updated system information.

146. The method of claim 144, wherein the second duration is equal in time to the fourth duration.

147. A method for handling time-based merchandising and providing access control, the method comprising:
receiving system information including subscription information for one or more service packages;
transmitting a subscription request including a service package selection;
receiving a service license message including one or more service keys for the selected service package;
receiving updated system information including subscription information for one or more service packages;
determining if the updated system information includes subscription information for the selected service package; and
deleting the one or more service keys for the selected service package if subscription information for the selected service package is not present in the updated system information.

148. The method of claim 147, wherein deleting the service keys terminates access to services associated with the service keys.

149. A computer program product comprising:
a processor-readable medium storing processor-readable instructions configured to cause a processor to:
create a package record for a first instance of a service package;
transmit system information to one or more user devices, wherein the system information includes information about the first instance of the service package indicating that the first instance of the service package is available for subscription;
close the first instance of the service package at a first time after a first duration;
create a package record for a second instance of the service package at the first time; and
transmit updated system information to the one or more user devices, wherein the updated system information includes information indicating that the first instance of the service package is closed and information about the second instance of the service package indicating that the second instance of the service package is available for subscription.

150. The product of claim 149, wherein closing the first instance of the service package indicates that the first instance of the service package is no longer available for subscription.

151. The product of claim 149, wherein the instructions are further configured to cause the processor to:
delete the package record for the first instance of the service package at a second time after a second duration; and
transmit updated system information to the one or more user devices, wherein the updated system information includes information indicating that the first instance of the service package is deleted.

152. The product of claim 151, wherein the information indicates that the first instance of the service package is deleted by omitting information about the first instance of the service package in the updated system information.

153. The product of claim 151, wherein the instructions are further configured to cause the processor to:
close the second instance of the service package at a third time after a third duration;
create a package record for a third instance of the service package at the third time; and
transmit updated system information to the one or more user devices, wherein the updated system information includes information indicating that the second instance of the service package is closed and information about the third instance of the service package indicating that the third instance of the service package is available for subscription.

154. The product of claim 153, wherein closing the second instance of the service package indicates that the second instance of the service package is no longer available for subscription.

155. The product of claim 153, wherein the first duration is equal in time to the third duration.

156. The product of claim 153, wherein the instructions are further configured to cause the processor to:
delete the package record for the second instance of the service package at a fourth time after a fourth duration; and
transmit updated system information to the one or more user devices, wherein the updated system information includes information indicating that the second instance of the service package is deleted.

157. The product of claim 156, wherein the information indicates that the second instance of the service package is deleted by omitting information about the second instance of the service package in the updated system information.

158. The product of claim 156, wherein the second duration is equal in time to the fourth duration.

159. A computer program product comprising:
a processor-readable medium storing processor-readable instructions configured to cause a processor to:
receive system information including subscription information for one or more service packages;
transmit a subscription request including a service package selection;
receive a service license message including one or more service keys for the selected service package;
receive updated system information including subscription information for one or more service packages;
determine if the updated system information includes subscription information for the selected service package; and
delete the one or more service keys for the selected service package if subscription information for the selected service package is not present in the updated system information.

160. The product of claim 159, wherein deleting the service keys terminates access to services associated with the service keys.

161. A mobile broadcast system configured to provide time-based merchandising and access control, the system comprising:
a means for creating a package record for a first instance of a service package;
a means for transmitting system information to one or more user devices, wherein the system information includes information about the first instance of the service package indicating that the first instance of the service package is available for subscription;
a means for closing the first instance of the service package at a first time after a first duration;
a means for creating a package record for a second instance of the service package at the first time; and
a means for transmitting updated system information to the one or more user devices, wherein the updated system information includes information indicating that the first instance of the service package is closed and information about the second instance of the service package indicating that the second instance of the service package is available for subscription.

162. The system of claim 161, wherein closing the first instance of the service package indicates that the first instance of the service package is no longer available for subscription.

163. The system of claim 161, further comprising:
means for deleting the package record for the first instance of the service package at a second time after a second duration; and
means for transmitting updated system information to the one or more user devices, wherein the updated system information includes information indicating that the first instance of the service package is deleted.

164. The system of claim 163, wherein the information indicates that the first instance of the service package is deleted by omitting information about the first instance of the service package in the updated system information.

165. The system of claim 163, further comprising:
means for closing the second instance of the service package at a third time after a third duration;
means for creating a package record for a third instance of the service package at the third time; and
means for transmitting updated system information to the one or more user devices, wherein the updated system information includes information indicating that the second instance of the service package is closed and information about the third instance of the service package indicating that the third instance of the service package is available for subscription.

166. The system of claim 165, wherein closing the second instance of the service package indicates that the second instance of the service package is no longer available for subscription.

167. The system of claim 165, wherein the first duration is equal in time to the third duration.

168. The system of claim 165, further comprising:
means for deleting the package record for the second instance of the service package at a fourth time after a fourth duration; and
means for transmitting updated system information to the one or more user devices, wherein the updated system information includes information indicating that the second instance of the service package is deleted.

169. The system of claim 168, wherein the information indicates that the second instance of the service package is deleted by omitting information about the second instance of the service package in the updated system information.

170. The system of claim 168, wherein the second duration is equal in time to the fourth duration.

171. A system configured for handling time-based merchandising and providing access control comprising:
means for receiving system information including subscription information for one or more service packages;
means for transmitting a subscription request including a service package selection;
means for receiving a service license message including one or more service keys for the selected service package;
means for receiving updated system information including subscription information for one or more service packages;
means for determining if the updated system information includes subscription information for the selected service package; and
means for deleting the one or more service keys for the selected service package if subscription information for the selected service package is not present in the updated system information.

172. The method of claim 171, wherein deleting the service keys terminates access to services associated with the service keys.
